(19) United States
(12) Patent Application Publication
(10) Pub. No.: US 2025/0284967 A1
(43) Pub. Date: Sep. 11, 2025

(54) ARTIFICIAL INTELLIGENCE CHATBOTS USING EXTERNAL KNOWLEDGE ASSETS

(71) Applicant: MicroStrategy Incorporated, Vienna, VA (US)

(72) Inventors: Will Hurwood, Washington, DC (US); Deepak Karuppiah, Vienna, VA (US); Ellen Wang, Great Falls, VA (US); Jaime Alberto Perez, Brambleton, VA (US); Qianping Jiang, Vienna, VA (US); Sheng Zhao, Great Falls, VA (US); Ananya Ojha, Dunn Loring, VA (US); Jeffrey Clay Courcelle, Atkinson, NH (US)

(21) Appl. No.: 19/192,700

(22) Filed: Apr. 29, 2025

Related U.S. Application Data
(63) Continuation of application No. 18/596,738, filed on Mar. 6, 2024.
(60) Provisional application No. 63/640,196, filed on Apr. 29, 2024.

(51) Int. Cl. G06N 3/0895

(52) U.S. Cl. CPC G06N 3/0895

(57) ABSTRACT

Methods, systems, and apparatus, including computer-readable media, for artificial intelligence chatbots using external knowledge assets. In some implementations, a system stores a knowledge base that comprises one or more knowledge items for an organization. The system receives a user prompt for a chatbot, and generates a chatbot response to the user prompt using one or more artificial intelligence and/or machine learning (AI/ML) chatbots. The chatbot response to the user prompt is generated at least in part based on the one or more AI/ML models processing the one or more knowledge items from the knowledge base. The system provides the chatbot response for presentation.

### CROSS-REFERENCE TO RELATED APPLICATIONS

This application is a continuation-in-part of U.S. patent application Ser. No. 18/596,738, filed on Mar. 6, 2024, and this application claims the benefit of priority to U.S. Provisional Patent Application No. 63/640,196, filed on Apr. 29, 2024, and the entire contents of the prior applications are hereby incorporated by reference herein.

### BACKGROUND

The present specification relates to techniques for customizing applications, interfaces, and modules that leverage artificial intelligence and machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users. Training the most capable models typically requires a very large amount of training data as well as large amounts of computing power and time. Many users use generalized models that are highly trained and highly capable, but are limited to default behavior and cannot be customized for particular uses or contexts.

### SUMMARY

In some implementations, a computer system provides access to artificial intelligence or machine learning chatbots, and allows organizations to customize the chatbots for their own use cases and data sets. The system can improve the usefulness and accuracy of the chatbots by enabling administrators to specify external knowledge assets to be provided to the chatbots. For example, an administrator can create a knowledge base that includes definitions, project names, organizational hierarchies, and other types of basic knowledge within the organization. The knowledge base can then be provided to AI/ML models with user questions and other user prompts to help the AI/ML models interpret the user prompts and generate relevant answers. As a result, the knowledge bases, customized for each organization, can enhance the effectiveness of chatbots by uploading an organization's unique language, including glossaries and jargon. As a result, if a user refers to an internal project code name in a prompt to a chatbot, the chatbot can use the information in the knowledge base to link that code name with other relevant records. As an example, if a user refers to a position or role in a company such as “head of engineering” in a prompt to a chatbot, then the chatbot can use organization data from the knowledge base to identify the person or role that is referred to. The customized knowledge assets can help ensure that chatbot responses are contextually relevant and precise.

The knowledge assets provided to a chatbot can provide a form of persistent memory, acting as long-term memory of information for an organization or group of users. This is particularly useful for AI/ML chatbots that generally act in a stateless manner and do not retain information unless it is provided as context data for a prompt. The knowledge assets can enhancing recall of a chatbot by improving the accuracy of interpretations and providing the link for chatbots to connect terms and phrases with data objects in data sets. This can improve the accuracy and relevance of responses for future queries across an organization. When a knowledge asset is shared among multiple chatbots, the capabilities of all the associated chatbots can be enhanced very quickly and easily through a single update to the knowledge asset. For example, if a new definition or explanation is added to a knowledge asset, all of the chatbots configure to use that knowledge asset can start making use of this new information where's the next prompt they receive.

In general, adding knowledge assets can increase chatbot effectiveness in answering questions containing synonyms, abbreviations, “business-speak,” and other types of uncommon terminology by cognitive matching against additional training assets uploaded by an administrator or other user.

In some implementations, it is desirable for a chatbot to be able to process data about data sets, including data object names, long descriptions, short descriptions, and attribute element text values. This information can be provided as part of a data model or data schema. However, the ability of a chatbot or AI/ML model to use this information is often limited without the definitions or descriptions that provide a logical link between the idiosyncratic terminology used in an organization to those data items. To help create this logical link, other knowledge assets can be uploaded by an administrator or other type of user to provide abbreviations, business overview and process knowledge that the chatbot can use to more effectively answer questions. This can involve providing unstructured data to provide better structured data analysis. In general, the easier chatbots are to control and richer the information they have access to for answering a user question, the better the accuracy and relevance of the chatbot responses.

The knowledge assets can assist chatbots to better interpret users' questions by making the chatbots extensible with domain knowledge, via a retrieval augmented generation (RAG)-based infrastructure that supports a Seed-Augment-Train pattern. The system allows customers to Seed domain knowledge (e.g. business glossary, terminology, acronym, synonym, specific definitions, e.g. Laboratory Reference Ranges in Healthy Adults) by explicitly uploading it, supporting unstructured, semi-structured and structured format like Word, Excel and PowerPoint documents, PDFs; or by pointing to repository of documents, or URLs of websites. The system then leverages the LLM to augment the domain knowledge, for example, by automatically generating synonyms, resolving or synthesizing acronyms, etc. The chatbot can then self-train by learning from user feedback: implicitly, for example by looking at usage, progression of questions; and explicitly through user feedback (e.g. answers to clarifying questions from the LLM; thumbs up/down).

In some implementations, the computer system enables the administrator to attach one or more additional data sets to adjust the operation and output of the chatbot. For example, an additional data set can be a knowledge base or data dictionary can be added. Unlike the primary data set that the user selects for the chatbot (e.g., data set 122a), the chatbot is not configured to answer questions about the additional data set or to retrieve metrics or to provide visualizations of the knowledge base. Instead, the knowledge base can be provided to assist the chatbot in interpreting user queries and providing responses with the terminology for the user's organization. In general, the knowledge base can function to provide contextual knowledge to the AI/ML models, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base is designated for the chatbot to describe these and other internal terms. For each user session or conversation with a chatbot, the knowledge base can be provided to assist the LLM with the context that is appropriate for the company. In some cases, some or all of the knowledge base content can be provided to the AI/ML models when the session or conversation is started, as part of initializing the chatbot. In addition, or as an alternative, each time the user submits a prompt, some or all of the knowledge base content can be provided with the prompt. In this situation, knowledge base content can be provided selectively based on the content of the prompt and potentially one or more other factors (e.g., recent history of the conversation). The knowledge base can provide information similar to a semantic graph, by describing entities and their relationships. In some cases, the information in the knowledge base can be derived from a semantic graph 150 and then converted into text (e.g., unstructured, semi-structured, or structured) in a format that can be processed by the LLM.

In general, the knowledge base or other additional data set can include data that maps terms or phrases to their meanings. In many cases, this can include semi-structured data or explanatory content, as a way to explain entities and relationships wo the AI/ML models. Although the knowledge base may include definitions, more generally the information may include descriptions of people, roles, business units, products, and other terms that may be referenced. The administrator may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases as contextual data sets that can be applied consistently across the enterprise, for all chatbots created and used in the enterprise. Similarly, different departments within the enterprise may add their own particular contextual data sets that may supplement the enterprise-wide knowledge bases. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases can additionally or alternatively be specified with a scope that corresponds to a computing environment, so that chatbots associated with a particular domain or server inherit the knowledge bases for that domain or server.

One of the advantages of the knowledge base is consistency for many users and even for many different chatbots of an organization. The user submitting a prompt does not need to take any action to select or include the knowledge base in the chatbot's processing, the chatbot automatically include the knowledge base in its context for each prompt or question received. Also, because the knowledge base can be shared or inherited by many chatbots within an organization, updating and maintaining the knowledge base is simple. An edit to the knowledge base is automatically applied to all of the chatbots associated with the organization, even if the chatbots were created by different administrators or provided to different sets of users.

In addition, the knowledge base provides persistent context that is not lost from one prompt to another or from one session to another. The knowledge base content can also be implemented applied in a manner that the knowledge base does not count toward the instruction token limits that the AI/ML models consume for each response. Rather than counting toward the tokens for prompts and recent history, the knowledge base can be accessed or provided to the AI/ML models as a separate source of knowledge apart from the prompt and context, and so does not count toward the token limits of an LLM. Implementations of access to the knowledge base can vary. For example, when a session with the chatbot is instantiated, the knowledge base can be provided as part of initializing the chatbot. In some cases, the AI/ML models are additionally or alternatively configured to access the primary dataset and if the user prompt includes a term or makes a request for an item not specified in the primary dataset, the chatbot is configured for the AI/ML models to then check the knowledge base or other contextual data sets. In some implementations, the knowledge base can be prepared as an embedding, a vector database, or other format that can be accessed by or referred to by the AI/ML models.

With the additional knowledge chatbot has three general sources of information before even receiving the user prompt. First, the chatbot has the primary dataset selected by the administrator, which is the primary source of answer for the chatbot. Second, the chatbot has a set of instructions that the administrator provided, e.g., general instructions such as the description of the primary dataset, the purpose of the chatbot, the type of user or type of task interacting with the chatbot, and a description of how the chatbot should form responses (e.g., response format, types of data to include, order of elements to include, etc.). Third, the chatbot has the knowledge base, which provides additional context behind the purpose of the bot and how the customer defines things. These types of information form a base level of information that is available for all users that use the chatbot. Also, for each user, the chatbot receives the user's prompt and also receives information about the conversation history of the user (e.g., previous queries and responses, from the current session and/or prior sessions).

In one general aspect, a method performed by one or more computers includes: storing, by the one or more computers, a knowledge base that includes one or more knowledge items, wherein the knowledge base stores information for an organization; receiving, by the one or more computers, a user prompt for a chatbot; generating, by the one or more computers, a chatbot response to the user prompt using one or more artificial intelligence and/or machine learning (AI/ML) chatbots, wherein the chatbot response to the user prompt is generated at least in part based on the one or more AI/ML models processing the one or more knowledge items from the knowledge base; and providing, by the one or more computers, the chatbot response for presentation.

In some implementations, the method includes providing an interface having controls configured to enable one or more administrators or users to edit the knowledge base by adding, altering, or removing knowledge items from the knowledge base.

In some implementations, the method includes: providing an interface having controls configured to enable one or more administrators or users to designate or upload a file as knowledge base content; and updating the knowledge base based on a file uploaded or designated for the knowledge base.

In some implementations, the method includes initializing a session of interaction with the chatbot, including by providing at least some of the knowledge base to the one or more AI/ML models such that the provided at least some of the knowledge base is in the context of the one or more AI/ML models for generating responses to user prompts during the session.

In some implementations, the at least some of the knowledge base is provided such that the provided at least some of the knowledge base is not included in a token count for incoming data to be processed by the one or more AI/ML models for user prompt processing during the session.

In some implementations, the one or more AI/ML models comprise a large language model (LLM); and the one or more computers cause the one or more knowledge items to be included in a context window of the LLM when the LLM is used to generate the chatbot response.

In some implementations, the method includes providing the one or more knowledge items to the one or more AI/ML models with a user prompt for the chatbot, such that the one or more AI/ML models receives the one or more knowledge items in association with the user prompt to generate the chatbot response.

In some implementations, the one or more knowledge items comprise at least one of a definition, a meaning of a nickname or alias, a synonym relationship, a meaning of an abbreviation, an organizational hierarchy, or a criterion to apply.

In some implementations, the one or more knowledge items indicate relationships between terminology used in the organization and data items indicated in a data model or data schema for one or more data sets that the chatbot is configured to answer questions about.

In some implementations, the one or more knowledge items are customized for the organization and are shared among multiple users in the organization, such that chatbot responses for the multiple users in the organization are generated based on information from the same one or more knowledge items.

In some implementations, the one or more knowledge items are configured to be used by each of multiple chatbots of the organization.

In some implementations, the one or more knowledge items act as a persistent memory across multiple sessions of use or conversations, for a group of multiple users in an organization and across multiple different chatbots used in the organization.

In some implementations, the one or more knowledge items are knowledge items are provided to the one or more AI/ML models as text or tokens representing text.

In some implementations, the one or more knowledge items are provided to the one or more AI/ML models as embeddings.

In some implementations, the one or more knowledge items comprise multiple knowledge items, and wherein the one or more computers are configured to selectively provide the multiple knowledge items to the one or more AI/ML models depending on the content of user prompts, such that different knowledge items or different subsets of the multiple knowledge items are provided to the one or more AI/ML models for generating responses to different user prompts.

In some implementations, the method includes: storing the one or more knowledge items using a vector database; and retrieving knowledge items for responding to a particular user prompt from the vector database.

In another general aspect, a method performed by one or more computers includes: providing, by the one or more computers, an interface for creating or editing an interactive application configured to provide responses generated using one or more artificial intelligence and/or machine learning (AI/ML) models; receiving, by the one or more computers, customization data through the interface, wherein the customization data indicates customizations specified by a user to customize the interactive application, wherein the customization data identifies a data set for the interactive application and specifies one or more characteristics of behavior of the interactive application; storing, by the one or more computers, one or more records specifying configuration settings representing the customizations for the interactive application; and providing, by the one or more computers, access to the interactive application with the customizations for one or more users, such that the interactive application is configured to generate a response to a user prompt using (i) a result determined from the data set based at least in part on the user prompt and (ii) content generated by the one or more AI/ML models from processing the result determined from the data set.

In some implementations, receiving the customization data comprises receiving one or more knowledge items specified by the user; the one or more records include or include a reference to the one or more knowledge items; and the interactive application is configured to provide the one or more knowledge items to the AI/ML models

In some implementations, the one or more AI/ML models comprise a large language model (LLM); and the one or more computers cause the one or more knowledge items to be included in a context window of the LLM when the LLM is used to generate content for the interactive application.

In some implementations, the interactive application is a chatbot, and wherein the method includes providing the one or more knowledge items to the one or more AI/ML models during initialization of a conversation or session of interaction with the chatbot, such that the one or more AI/ML models have the one or more knowledge items available to answer user prompts subsequently received during the conversation or session of interaction with the chatbot.

In some implementations, the interactive application is a chatbot, and wherein the method includes providing the one or more knowledge items to the one or more AI/ML models with a user prompt for the chatbot, such that the one or more AI/ML models receives the one or more knowledge items in association with the user prompt to generate a response to the user prompt.

In some implementations, the one or more knowledge items comprise at least one of a definition, a meaning of a nickname or alias, a synonym relationship, a meaning of an abbreviation, an organizational hierarchy, or a criterion to apply.

In some implementations, the one or more knowledge items indicate relationships between terminology used in an organization and data items indicated in a data model or data schema for one or more data sets.

In some implementations, the one or more knowledge items are customized for an organization and are shared among multiple users in the organization, such that chatbot responses for the multiple users in the organization are generated based on information from the same one or more knowledge items.

In some implementations, the one or more knowledge items are configured to be used by each of multiple chatbots of the organization.

In some implementations, the one or more knowledge items act as a persistent memory across multiple sessions of use or conversations, for a group of multiple users in an organization and across multiple different chatbots used in the organization.

In some implementations, the one or more knowledge items are knowledge items are provided to the one or more AI/ML models as text.

In some implementations, the one or more knowledge items are provided to the one or more AI/ML models as embeddings.

In some implementations, the one or more knowledge items comprise multiple knowledge items, and wherein the one or more computers are configured to selectively provide the multiple knowledge items to the one or more AI/ML models depending on the content of user prompts, such that different knowledge items are provided to the one or more AI/ML models for different user prompts.

In some implementations, the one or more computers selectively provide knowledge items to the one or more AI/ML models for responding to a user prompt using a result-augmented generation (RAG) process that selects from among the multiple knowledge items based on relevance or similarity of (i) one or more vector embeddings representing the user prompt to (ii) vector embeddings representing the respective knowledge items.

In some implementations, the method comprises: storing the one or more knowledge items using a vector database; and retrieving knowledge items for responding to a particular user prompt from the vector database.

In some implementations, the interactive application comprises a chatbot, and the one or more AI or machine learning models comprises a large language model.

In some implementations, providing the interface comprises providing data for a user interface of a web page or web application.

In some implementations, providing the interface comprises providing an application programming interface.

In some implementations, providing the interface comprises providing user interface data for a user interface comprising (i) a set of interactive elements to that are selectable by a user to change settings of the interactive application, and (ii) a region for interacting with the interactive application, including an input control configured to submit user prompts and an output area configured to provide responses of the interactive application to the user prompts.

In some implementations, the interface includes one or more controls to alter an appearance of the interactive application; the customization data indicates customizations specified by the user that include changes to the appearance of the interactive application; and the stored one or more records indicate the changes to the appearance of the interactive application.

In some implementations, the interface includes one or more controls to alter one or more messages to provide to users of the interactive application; the customization data indicates customizations specified by the user that include the one or more messages; and the stored one or more records indicate the one or more messages to provide to users of the interactive application.

In some implementations, the interface includes one or more controls to set whether the interactive application can use information from the Internet to respond to user prompts; the customization data indicates customizations specified by the user that include a setting whether the interactive application can use information from the Internet to respond to user prompts; and the stored one or more records indicate the setting whether interactive application can use information from the Internet to respond to user prompts.

In some implementations, the interface includes one or more controls to control access to the interactive application by users; the customization data indicates customizations specified by the user that adjusts which users can access the interactive application; and the stored one or more records indicate criteria specifying which users can access the interactive application.

In some implementations, the interface includes one or more controls to limit an amount of usage of the interactive application by users; the customization data indicates customizations specified by the user that set a limit on the amount of usage of the interactive application by users; and the stored one or more records indicate the limit on the amount of usage of the interactive application by users.

In some implementations, the interface includes one or more controls to limit the portions of the data set that can be used to generate responses provided by the interactive application; the customization data indicates customizations specified by the user that specify a subset of the data set to be used by the interactive application to generate responses; and the stored one or more records indicate the subset of the data set to be used by the interactive application to generate responses.

In some implementations, the interactive application is configured to vary which portions of the data set are used to provide responses by the interactive application to different users based on respective permissions or access levels of the different users.

In some implementations, the one or more AI or machine learning models comprises a third-party AI or machine learning model; and the interactive application is configured to generate responses to user prompts based on (i) generating results to the user prompts from the data set using a data processing system, and (ii) providing the generated results to the third-party AI or machine learning model, so that the third-party AI or machine learning model generates content for the responses without direct access to the data set.

In some implementations, the result comprises result data generated by a database management system based on a query or set of processing operations determined using the user prompt; and the interactive application is configured to obtain the content from the one or more AI or machine learning models by requesting that the one or more AI or machine learning models summarize results from the database system.

In some implementations, the interactive application is configured to generate a response to a user prompt by performing operations including: sending a first request to the one or more AI or machine learning models based on the user prompt, wherein the first request requests instructions for analyzing the data set based on the user prompt; causing data processing instructions that the one or more AI or machine learning models generated in response to the first request to be carried out using deterministic processing of a data processing system separate from the AI or machine learning models; sending a second request to the one or more AI or machine learning models, including results generated by carrying out the data processing instructions and a request to generate text based on the results; and providing, in a response to the user prompt, text that the one or more AI or machine learning models generated in response to the second request.

In some implementations, the first request is a request for instructions specified in code of a programming language; and wherein causing the data processing instructions to be carried out comprises causing the instructions specified by the code of the programming language to be performed.

In some implementations, the interactive application is configured to respond to at least some user prompts with data for a visualization of data from the data set, wherein the interactive application is configured to request and receive data describing characteristics of the visualization from the one or more AI or machine learning models.

In some implementations, the visualization comprises a chart or graph of a type of data indicated by the one or more AI or machine learning models based on information from a user prompt, with the chart or graph depicting values for the type of data wherein the values are determined by a database system separate from the one or more AI or machine learning models.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1A and 1B are diagrams showing an example of a system for creating, distributing, and using customized chatbots.

FIG. 2A is a diagram showing an example of knowledge base content.

FIGS. 2B-2E are diagrams showing examples of user interface for chatbots.

FIGS. 3A to 13 are user interface diagrams illustrating examples of creating, distributing, and using customized chatbots.

Like reference numbers and designations in the various drawings indicate like elements.

### DETAILED DESCRIPTION

In some implementations, a computer system provides functionality for creating and distributing customized interactive applications, such as chatbots, that provide responses using artificial intelligence or machine learning (AI/ML) models, such as large language models (LLMs). For example, the computer system can provide an interface through which a user, such as an administrator, can create or edit an interactive application. The computer system can provide an initial base application or template that includes the core functionality that enables users to obtain content from an AI/ML model. The administrator can use the interface customizations that alter the appearance and behavior of the interactive application, so the customized application provided to users will operate as the administrator intends. The customizations can include, for example, specifying the data sources available to be used in responding to user prompts (e.g., questions or statements input to a chatbot), as well as whether information from the Internet or other external sources can be used in generating responses. The interface also allows the administrator to set user access control and usage limits for the interactive application, to control resource consumption and costs incurred by repeated inference processing using AI/ML models.

After the administrator customizes the interactive application using the interface, the computer system saves the interactive application (e.g., as a new or updated chatbot) and makes the application available to other users. For example, the computer system can send hyperlinks or invitation messages to users, so the users can access a customized chatbot through a web page or web application. As another example, the computer system can include code to integrate the customized chatbot into an existing web page or web application (e.g., as an embedded item, in an iFrame, etc.). As another example, the computer system can integrate with document libraries, file browsers, document viewers, web browsers, or other types of user interfaces. As a result, the customized chatbot can be made available through any of various enterprise software platforms and applications. The interface of the customized chatbot can then be invoked by interacting with an icon or menu item for the customized chatbot, or by entering a user prompt into a text entry field of a user interface. In some implementations, the interface of the chatbot can be provided together with a document viewer, for example, in a sidebar or tab shown concurrently with the document viewer interface. This arrangement can enable the user to view a document, such as a dashboard related to a data set, while concurrently having a conversation with a customized chatbot designed to answer questions about the data set.

The computer system enables interactive applications to be tailored or targeted for specifics data sets. For example, each interactive application that is created or customized can provide responses with information derived from a corresponding data set specified by the administrator, such as a private data set (e.g., a database table, a data cube, a spreadsheet, etc.). The system enables administrators to create and deploy multiple interactive applications concurrently. For example, different chatbots that have different behavior tailored for different sets of users. Similarly, different chatbots can be configured to provide data from different source data sets. Administrators can create and deploy different instances of chatbots and other interactive applications, each with customized behavior, appearance, and other characteristics as appropriate for their respective data sets and users.

The computer system enables administrators to customize AI/ML-enabled chatbots very quickly, without the need to re-train an AI/ML model. In particular, after specifying the customizations for the chatbot, no model training is needed and so the customized chatbot can be used right away. The system can provide a preview interface or test interface that enables an administrator to change chatbot settings and try out the updated chatbot in the generation or editing interface, to see the effects of changes in real time or near real time. To facilitate customizability and the rapid generation of chatbots, the customizations to the chatbot can be made outside the training state of the AI/ML chatbot itself, for example through the selection of which existing AI/ML model(s) to be used, which data set(s) being used, which portions of a data set are accessible, and the parameters or characteristics of interactions with the AI/ML model(s). Customizations can also be implemented in operations of a non-AI/ML processing system, for functions such as access control, precision or granularity of data access, and so on. With the ability to provide customized chatbots without the need to train or re-train AI/ML models, the system allows rapid generation and deployment of chatbots with minimal up-front computing resources and no training delay.

The computer system can support interactive applications where processing tasks for responding to a user prompt are split between non-AI/ML or non-probabilistic data processing systems AI/ML models (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying data set that the chatbot is based on. Indeed, in many cases, the AI/ML model does not receive even portions of the actual data set, and instead receives only metadata describing the general contents and/or structure of the data set (e.g., types of metrics and attributes, semantic meaning of the columns, etc.) and potentially sample data (e.g., fictitious examples that illustrate the type of content in the data set without revealing the actual values and records). In addition to enhancing privacy, this also increases speed and reduces network transfer requirements, since the data set does not need to be sent over a network and the data set itself does not need to be processed by the AI/ML model. The process also allows the data processing system (e.g., an enterprise database management system) to reliably apply security policies and access control over the data set that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying data set itself. As a result, the system avoids granting the AI/ML model—and any third-party providing the AI/ML model as a service—access to portions of the data set that are not appropriate for answering the current question.

The customizations that the administrator set in creating or customizing the chatbot can be used to alter the operation and results of the non-AI/ML data processing system, the AI/ML model, the front-end interface that the user sees, or a combination of any or all of them. For example, the customizations that the administrator selects can specify which data set(s) to use when answering questions, whether additional public data sets or the Internet can be used to answer questions, which portions (e.g., columns, rows, data types, etc.) of data sets can be accessed, and so on. In addition, the customizations that the administrator selects can specify output characteristics for the chatbot such as the style, formatting, media type (e.g., text, images, text and images, etc.), and other properties of answers.

In some implementations, the customized chatbots can be configured to generate visualizations in response to questions and other user prompts. These visualizations can also be generated through a combination of processing by AI/ML models and non-AI/ML processing systems. For example, if a user prompt requests a visualization or if a visualization is otherwise appropriate for a response, the AI/ML model can specify the type of visualization (e.g., bar chart, line graph, pie chart, etc.) and other properties (e.g., data series shown, scale and data on the axes, etc.). The actual values to be displayed in the visualization, however, can be calculated by the non-AI/ML processing system, using reliable and accurate calculations from the data set. As a result, the AI/ML system can design and format a visualization appropriate to answer the user prompt, while the actual data populating the visualization is not subject to the uncertainties of AI/ML processing.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary data sets, the chatbots can be more easily integrated with the processing capabilities of third-party systems.

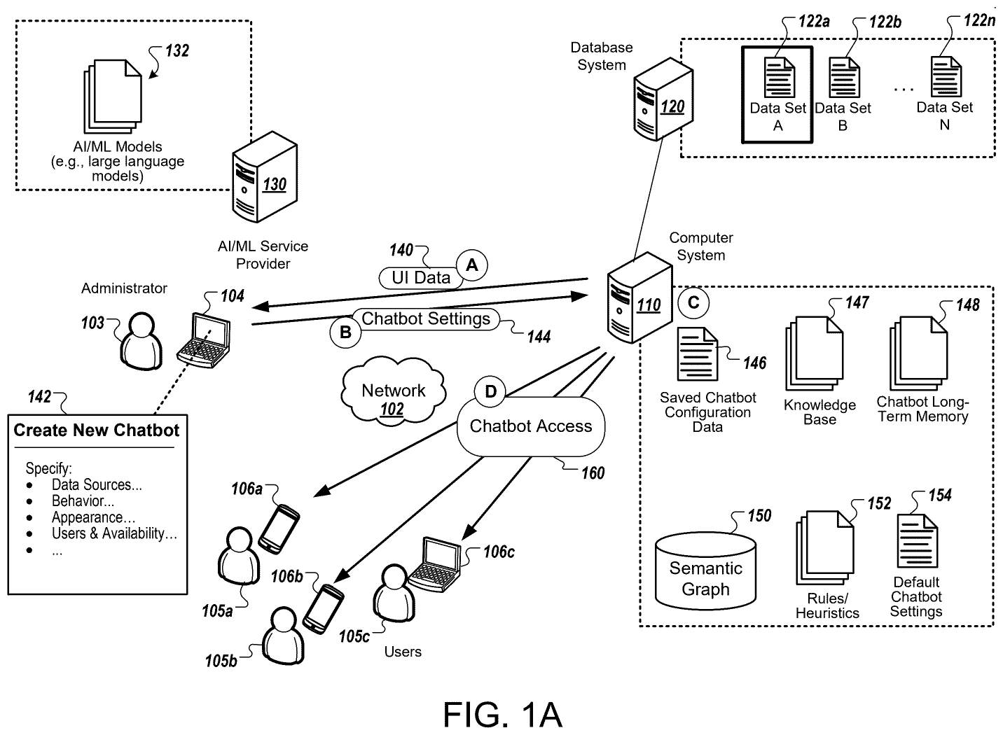

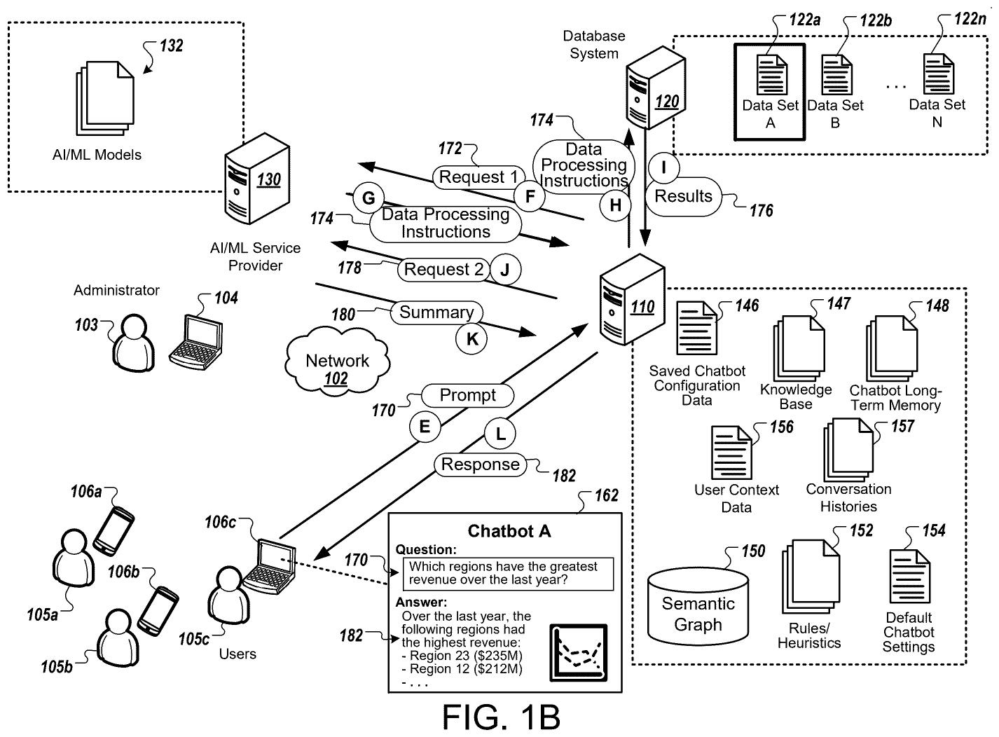

FIGS. 1A-1B are diagrams showing an example of a system 100 for creating, distributing, and using interactive applications such as customized chatbots. The system 100 includes a computer system 110, a database system 120, and a AI/ML service provider 130. The elements of the system 100 communicate over a network 102, such as the Internet. The computer system 110 coordinates a variety of functions for creating and operating chatbots. For example, the computer system 110 interacts with a client device 104 of an administrator 103 to receive customization data that indicates customizations for a chatbot. The computer system 110 then provides access to the customized chatbot to client devices 106a-106c of other users 105a-105c, and the computer system 110 coordinates processing to generate and provide answers to questions and other user prompts provided to the customized chatbot.

The example of FIGS. 1A-1B includes stages (A) to (L), which represent various operations and a flow of data, and which can occur in the order illustrated or in a different order. In FIG. 1A, stages (A) to (D) show an example of creation of a customized chatbot and access being provided to users. In FIG. 1B, stages (E) to (L) show an example of the customized chatbot being used, from issuance of a question or prompt 170 from a user to display of a response 182 from the customized chatbot.

The computer system 110 can be implemented using one or more servers, including one or more cloud computing systems. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. As discussed further below, the computer system 110 performs various other functions to generate and save customized chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various data sets 122a-122n, which can be private data sets for organization, such as a company. The database system 120 can store and use data sets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

As an overview, to create a customized chatbot, the administrator 103 interacts with the computer system 110 to specify the features and behavior that are desired for the chatbot. Through a series interactions, the administrator 103 can specify characteristics such as which data set(s) 122a-122n the chatbot will use to generate responses, the appearance and style of the chatbot interface, whether the chatbot can access data from the Internet or other sources, access control settings, and so on. The computer system 110 saves the settings specified by the administrator 103 and creates a new chatbot

To provide the interface, the computer system 110 can provide data for a web application, web page, or native application that, when rendered on a client device, provides the functionality to specify settings of the chatbot being created or edited.

In stage (A), the computer system 110 provides user interface data 140 to the client device 104 over the network 102. For example, the computer system 110 can provide content of a web page or web application for creating or editing the customized chatbot. The user interface data 140 is rendered on the display of the client device 104, represented by user interface 142.

The user interface 142 provides controls to specify many different properties of the chatbot. For example, the user interface 142 enables the administrator 103 to specify the data source or data set that the chatbot will draw from to provide responses. The user interface 142 also allows the administrator 103 to specify various aspects of the behavior of the chatbot, including suggestions, instructions to the user, and more. The user interface 142 also includes controls for the administrator 103 to specify characteristics of the appearance of the chatbot, including color schemes, layout, formatting, size, and other characteristics. The user interface 142 also includes controls for the administrator 103 to specify access control, such as to specify which users can access the chatbot, the number or frequency of questions users are permitted issue to the chatbot, the platforms or interfaces in which the chatbot is available, and so on.

In stage (B), the administrator 103 uses the interface 142 to enter the settings that customize the appearance and operation of the chatbot. The client device 104 sends the specified settings 144 to the computer system 110 over the network 102.

As an example, the administrator 103 selects a particular data set 122a as the data source for the chatbot, as a result, the chatbot will generate responses based on the information in this data set 122a. In some implementations, each chatbot is focused on a specific data set or collection of records. This can allow the chatbot to be tailored closely to a specific application, task, purpose, or set of users or roles in an organization. In addition, limiting the scope of data that the chatbot can access can improve accuracy in responses by limiting the amount of extraneous information that might otherwise be introduced. In addition, focusing a chatbot on a specific data set can increase performance and reduce response times, by reducing the complexity and amount of data that needs to be processed to generate answers.

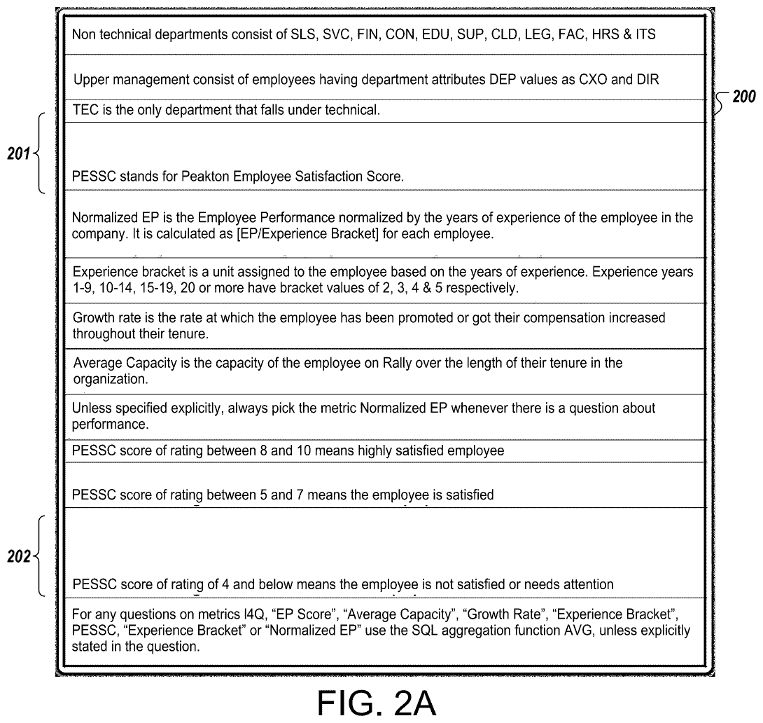

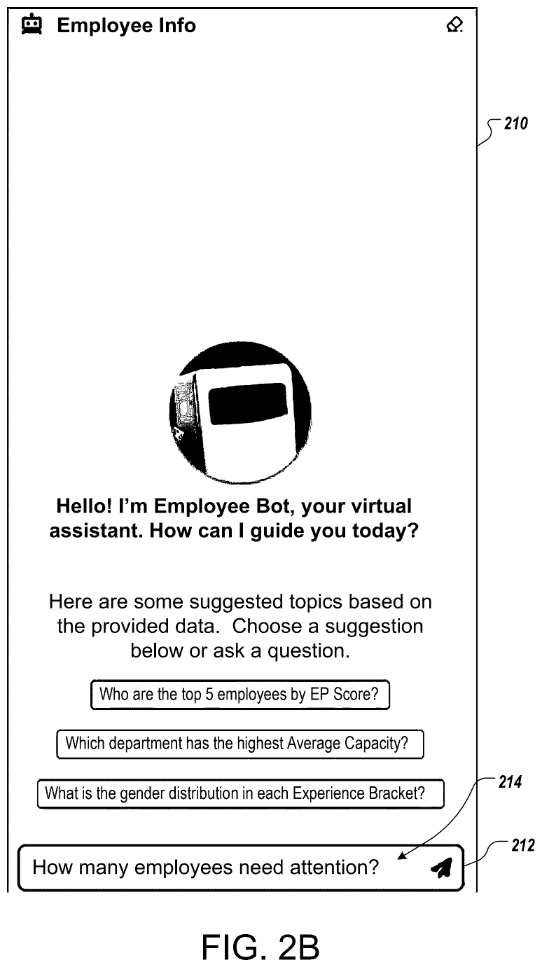

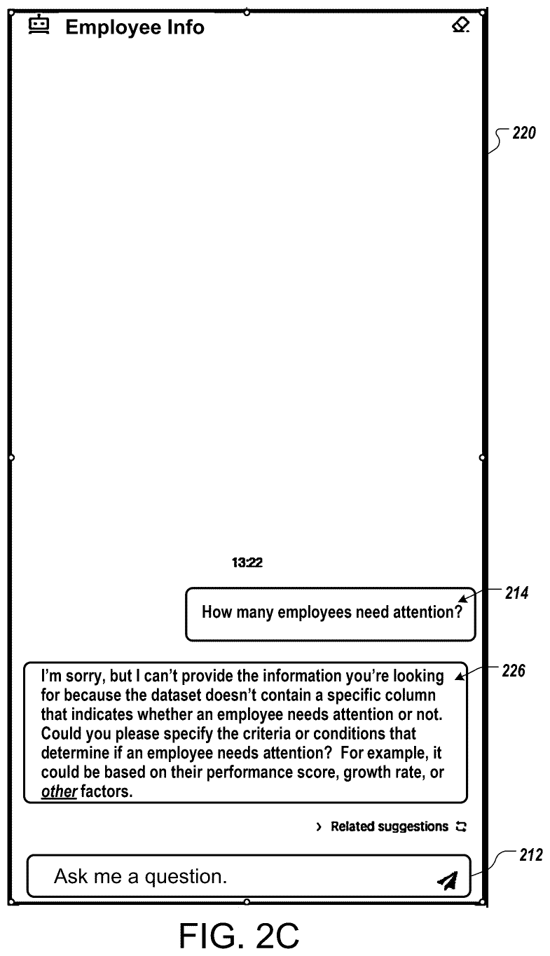

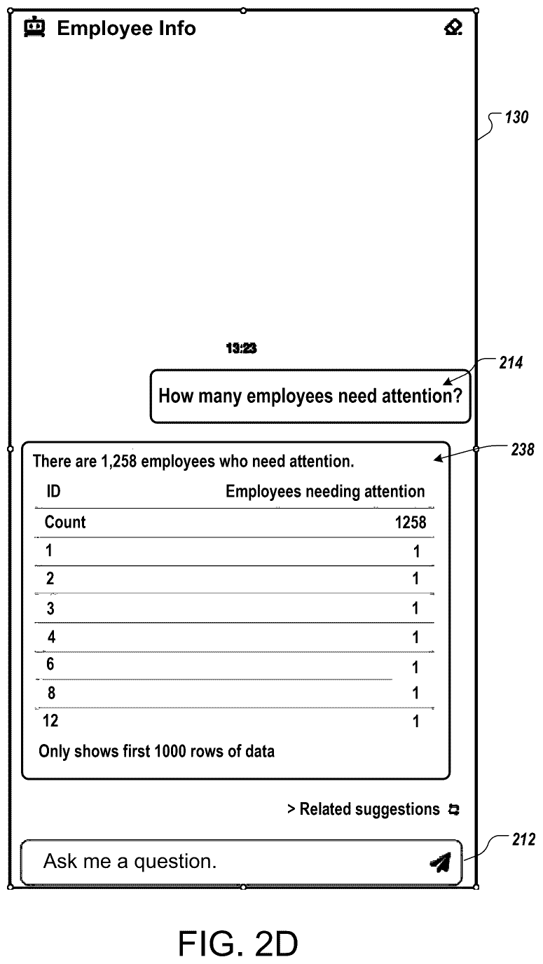

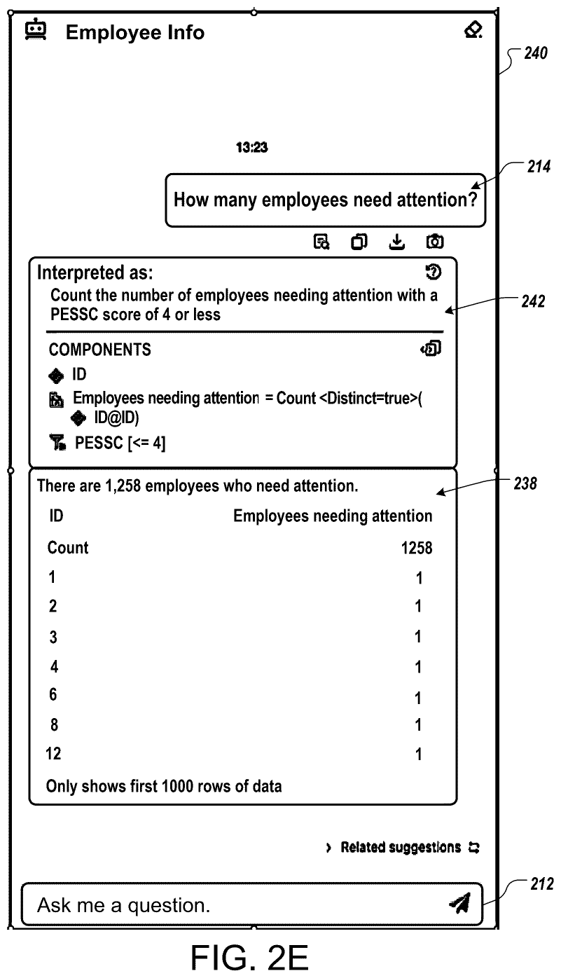

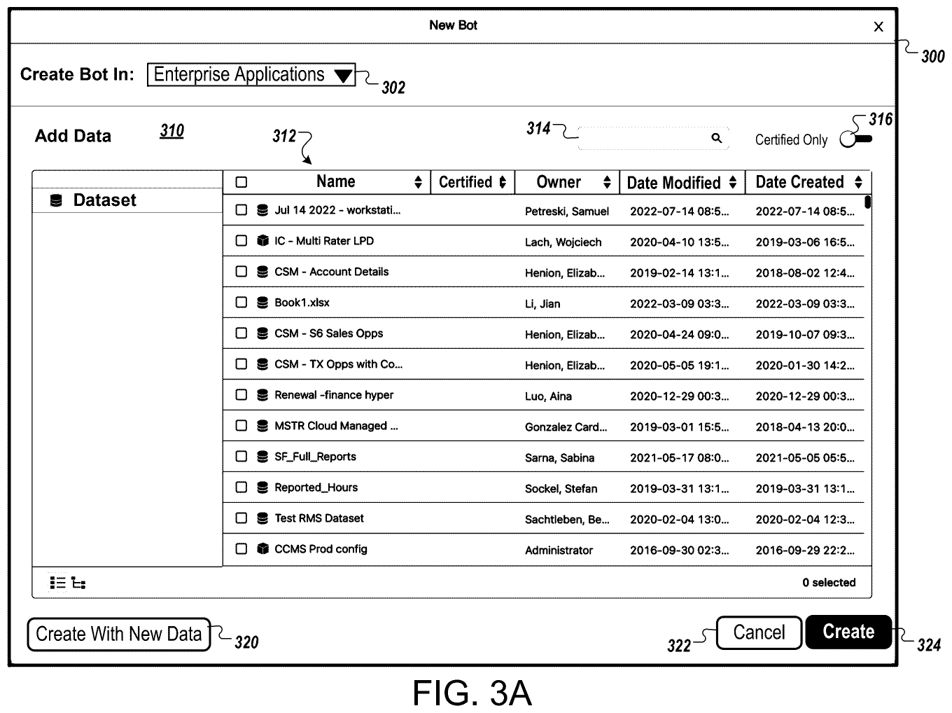

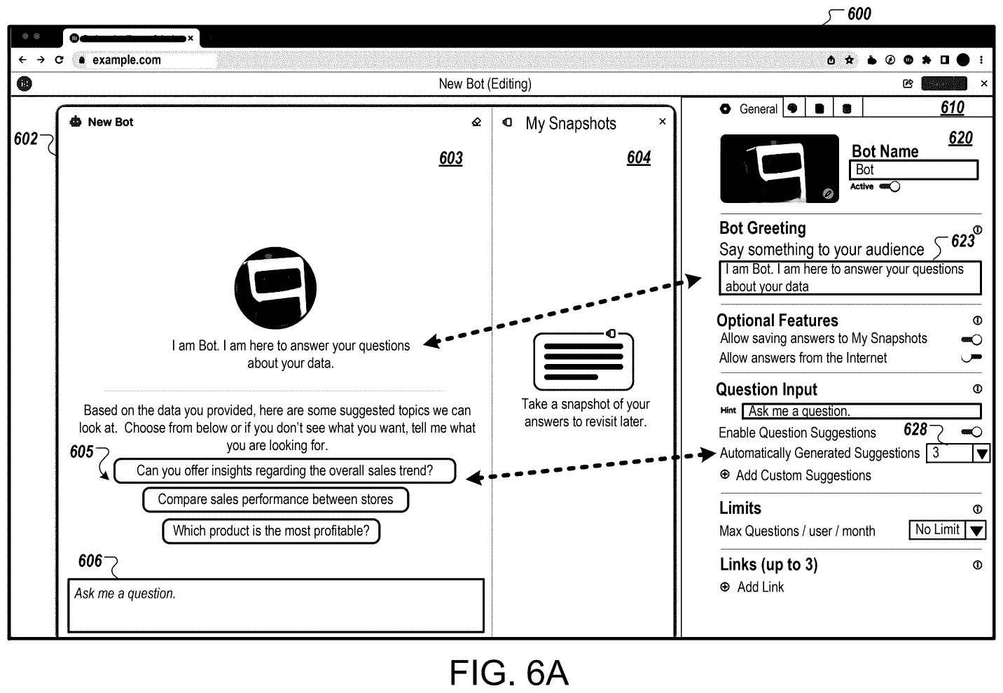

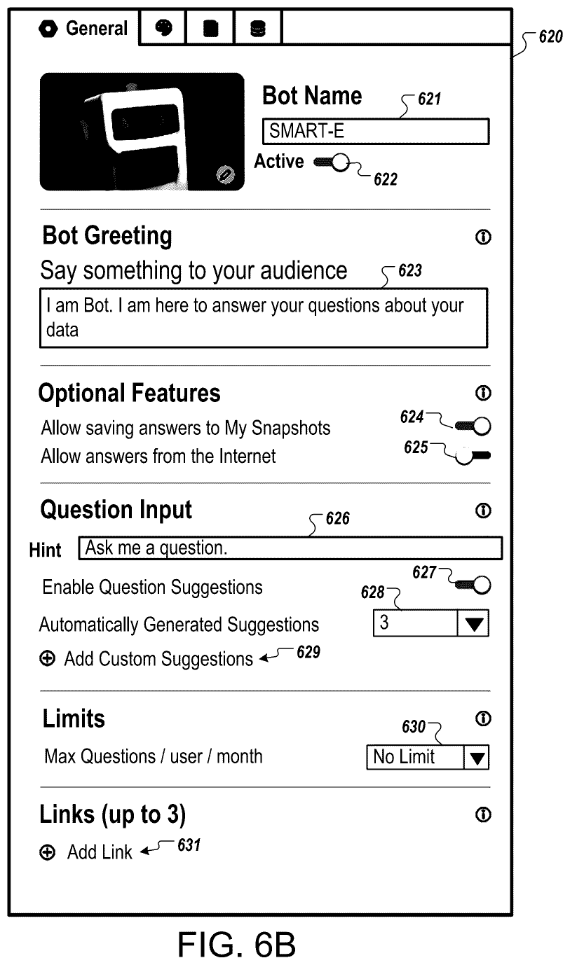

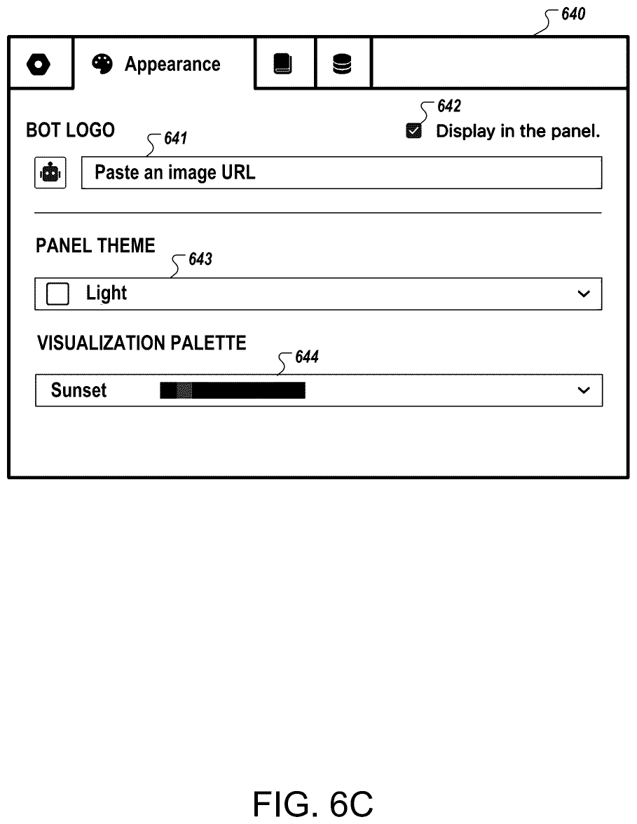

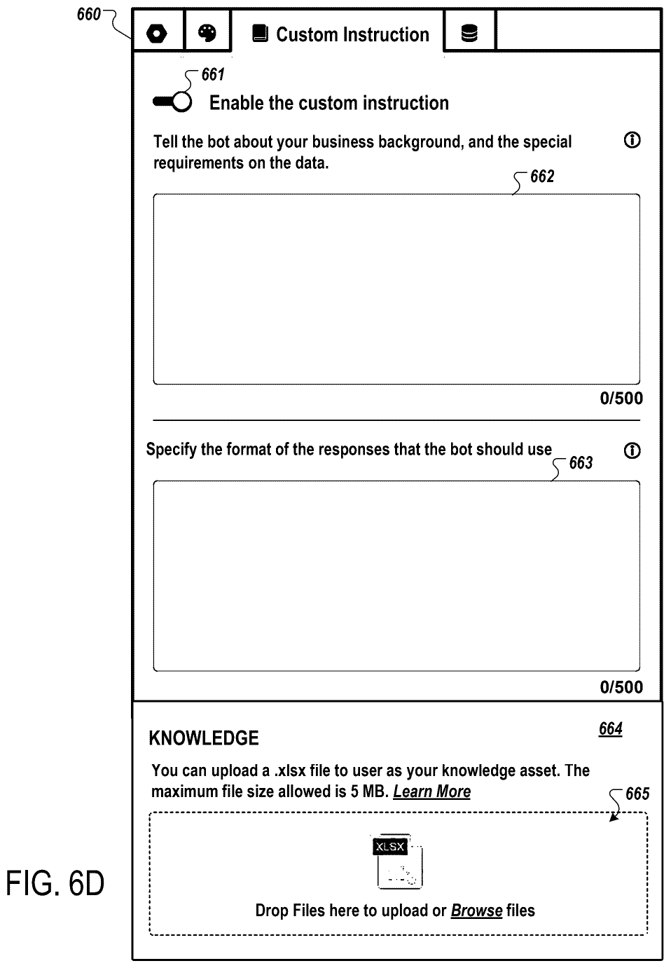

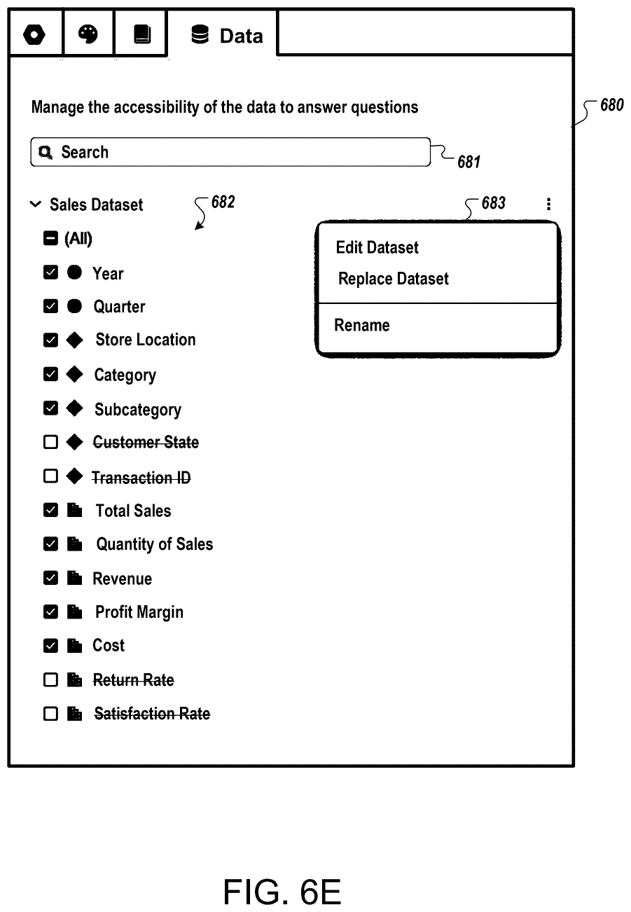

The process of specifying the settings for the chatbot can be iterative, with potentially multiple rounds of the administrator 103 interacting with the user interface 142 to incrementally adjust and test the settings of the chatbot. For example, as discussed below for FIG. 6A, the user interface 142 can provide a preview area or test panel in which the chatbot can run and provide interactions with the administrator 103 during the process of specifying the customized chatbot settings 144. As the administrator 103 makes changes to the chatbot settings, the administrator 103 can issue questions to the chatbot and evaluate the responses and interaction behavior with the newly updated settings, allowing the administrator 103 to make further changes based on the results experienced. FIGS. 2-6E, discussed further below, show examples of the user interface 142 and further illustrate the types of settings that can be adjusted to customize the chatbot.

Referring still to FIG. 1A, in stage (C), the computer system 110 uses the customized chatbot settings 144 from the administrator 103 to generate and save the data and settings that define the chatbot. In the example, this is shown as saved chatbot configuration data 146. For example, the computer system 110 can create a record or series of records representing the new chatbot and its customized settings. For each chatbot, the computer system 110 saves a separate set of records or definitions that specify the characteristics and customizations of that chatbot. For example, each chatbot can have a set of saved chatbot configuration data 146 that specifies, among other items, the name of the chatbot, the data set for the chatbot, a selection of which AI/ML models 132 to use for the chatbot, the appearance and formatting characteristics of the chatbot, access control information for the chatbot, customized instructions to append to or include in user prompts to AI/ML models, and so on.

The computer system 110 can include a number of modules and data sets that facilitate the generation of new chatbots. For example, the computer system 110 can include a set of default chatbot settings 154 that provides a default or base configuration for new chatbots. The customizations specified in the received chatbot settings 144 can override or replace settings in the default set of chatbot settings 154 to form the final set of saved chatbot configuration data 146.

Generating and saving the chatbot can include registering the chatbot with a number of different applications, web pages, web applications, or other services. For example, the computer system 110 can register the new chatbot, with its name, capabilities, and applicable context, so that the option for the chatbot appears for users who have been granted access. For example, the chatbot can be made available through the document libraries of users who are approved to access the chatbot.

In some implementations, the computer system 110 enables the administrator 103 to attach one or more additional data sets to adjust the operation and output of the chatbot. For example, an additional data set can be a knowledge base 147 or data dictionary can be added. Unlike the primary data set that the user selects for the chatbot (e.g., data set 122a), the chatbot is not configured to answer questions about the additional data set or to retrieve metrics or to provide visualizations of the knowledge base 147. Instead, the knowledge base 147 can be provided to assist the chatbot in interpreting user queries and providing responses with the terminology for the user's organization. In general, the knowledge base 147 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 147 is designated for the chatbot to describe these and other internal terms. Each time the user submits a prompt, the knowledge base 147 can be provided to assist the LLM with the context that is appropriate for the company. The knowledge base 147 can provide information similar to a semantic graph, by describing entities and their relationships. In some cases, the information in the knowledge base 147 can be derived from a semantic graph 150 and then converted into text (e.g., unstructured, semi-structured, or structured) in a format that can be processed by the LLM.

In general, the knowledge base 147 or other additional data set can include data that maps terms or phrases to their meanings. In many cases, this can include semi-structured data or explanatory content, as a way to explain entities and relationships wo the AI/ML models 132. Although the knowledge base 147 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 147 as contextual data sets that can be applied consistently across the enterprise, for all chatbots created and used in the enterprise. Similarly, different departments within the enterprise may add their own particular contextual data sets that may supplement the enterprise-wide knowledge bases 147. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 147 is consistency for many users and even for many different chatbots of an organization. The user submitting a prompt does not need to take any action to select or include the knowledge base 147 in the chatbot's processing, the chatbot automatically include the knowledge base 147 in its context for each prompt or question received. Also, because the knowledge base 147 can be shared or inherited by many chatbots within an organization, updating and maintaining the knowledge base 147 is simple. An edit to the knowledge base 147 is automatically applied to all of the chatbots associated with the organization, even if the chatbots were created by different administrators or provided to different sets of users.

In addition, the knowledge base 147 provides persistent context that is not lost from one prompt to another or from one session to another. The knowledge base content can also be implemented applied in a manner that the knowledge base 147 does not count toward the instruction token limits that the AI/ML models 132 consume for each response. Rather than counting toward the tokens for prompts and recent history, the knowledge base 147 can be accessed or provided to the AI/ML models 132 as a separate source of knowledge apart from the prompt and context, and so does not count toward the token limits of an LLM. Implementations of access to the knowledge base 147 can vary. For example, when a session with the chatbot is instantiated, the knowledge base can be provided as part of initializing the chatbot. In some cases, the AI/ML models 132 are additionally or alternatively configured to access the primary data set and if the user prompt includes a term or makes a request for an item not specified in the primary data set, the chatbot is configured for the AI/ML models 132 to then check the knowledge base or other contextual data sets. In some implementations, the knowledge base 147 can be prepared as an embedding, a vector database, or other format that can be accessed by or referred to by the AI/ML models 132.

With the additional knowledge chatbot has three general sources of information before even receiving the user prompt. First, the chatbot has the primary data set (e.g., data set A 122a) selected by the administrator 103, which is the primary source of answer for the chatbot. Second, the chatbot has a set of instructions that the administrator 103 provided, e.g., general instructions such as the description of the primary data set, the purpose of the chatbot, the type of user or type of task interacting with the chatbot, and a description of how the chatbot should form responses (e.g., response format, types of data to include, order of elements to include, etc.). Third, the chatbot has the knowledge base, which provides additional context behind the purpose of the bot and how the customer defines things. These types of information form a base level of information that is available for all users that use the chatbot. Also, for each user, the chatbot receives the user's prompt and also receives information about the conversation history of the user (e.g., previous queries and responses, from the current session and/or prior sessions).

In some implementations, the chatbot is designed to have a long-term memory 148, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 148 for the chatbot. For example, the long-term memory 148 can store items such as definitions of terms for a particular user context, unique text elements the chatbot might encounter, and feedback from prior user interactions.

One valuable aspect of the long-term memory 148 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 148 designated for the chatbot. Each chatbot that is created can have its own long-term memory 148, which is updated by the interactions of its own users. Before the computer system 110 asks the stateless LLM to provide a response to a user prompt, the computer system 110 facilitates retrieval of data from the long-term memory 148, potentially to provide customized instructions or additional contextual data to accompany the user prompt and tailor the response based on what has been learned from prior interactions. The long-term memory 148 thus provides better reference data for LLM to use in guiding answer generation.

The long-term memory 148 can include business definitions of other users have specified or uploaded. In this way, the long-term memory 148 can supplement or expand on the descriptions provided in the knowledge base 147. The chatbots can be configured to learn at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

In stage (D), the computer system 110 provides access to the chatbot to various users. 105a-105c. For example, the chatbot settings 144 specified by the administrator 103 can specify access control parameters that indicate groups of users or individual users or categories of users who receive access to the new chatbot. The computer system 110 provides access to the chatbot to authorized users in any of various ways. For example, the computer system 110 can send a message to authorize users with a URL or other link to web page, web application, or native application functionality providing the chatbot interface. As another example, the computer system 110 can update and interface such as a document library, dashboard, or other user interface to include a panel with the chatbot interface, or to include an icon, button, or other control that is interactive so that users can interact to request that the chatbot interface be provided.

Referring to FIG. 1B, after the chatbot has been customized and saved, a user 105c interacts with the chatbot. For example, the user 105c accesses a user interface 162 for the chatbot. The user interface 162 includes a field in which the user can enter a question or other user prompt 170. In the example, the user 105c enters the prompt 170, and the user's client device 106c sends the prompt 170 to the computer system 110 for processing. The computer system 110 receives the prompt 170 and begins a series of interactions used to generate the response to the prompt 170.

As discussed above, the chatbot has an associated knowledge base 147 that can include, for example, descriptions of terms that may have a unique meaning in the particular context of the user. The knowledge base 147 may be shared by multiple chatbots or even all chatbots associated with the company or organization of the user. When the computer system 110 establishes a new session of the chatbot and a user, the computer system 110 can provide the knowledge base 147 as part of initializing the session with the AI/ML model 132. As a result, the knowledge base 147 can provide additional context for all of the subsequent interactions with the AI/ML model 132.

In addition, the chatbot has information in its long-term memory 148 that has been learned through previous interactions with users. This information can be provided upon initialization of the chatbot, as the knowledge base 147 is, or can be provided in other ways. For example, the information from the long-term memory 148 can be selectively and contextually applied, as the computer system 110 analyzes the prompt 170 and determines whether there is information in the long-term memory 148 that is relevant to the content of the prompt 170. The retrieved content of the long-term memory 148 that the computer-system 148 determined to be relevant to the prompt, can then be provided with the prompt 170. As another example, certain information in the long-term memory 148 may be applicable to a specific user, role, or permission level, and the computer system 110 can provide that information in response to determining that the user 105c submitting the prompt 170 is that user or has that role or permission level. In other cases, the information in the long-term memory 148 supplements or alters the general instructions or initialization commands for starting the chatbot session, either in all cases or selectively when specific prompt content or user context is detected.

In stage (F), the computer system 110 generates and sends a first request 172 to the AI/ML service provider 130. The first request 172 includes the prompt 170 and information about the data set 122a, and represents a request for an AI/ML model 132 to generate instructions for answering the prompt 170. For example, rather than asking the AI/ML model 132 for the answer to the prompt 170, the first request 172 can request a SQL statement, programming code, a list of operations, or other instructions that specify how to retrieve or calculate and answer to the prompt 170. As a simple example, the prompt to the LLM in the first request 172 may include an instruction such as “provide a SQL statement that retrieves the data needed to answer the question <<user prompt>>,” or “generate Python code that can run on <<database system>> to calculate the answer to the question <<user prompt>>.” The content of the first request 172 can be designed for the particular AI/ML model 132 and its capabilities.

As a result, the first request 172 can be a request for a SQL statement or Python code that, when interpreted or executed by another system such as the database system 120, will cause the other system to retrieve and/or generate a focused subset of data (e.g., a result data set) from the data set 122a that can be used to answer to the prompt 170 from the data set 122a. The first request 172 can also include one or more custom instructions that the administrator 103 specified, to further orient the AI/ML model 132 to generate data processing instructions that are most applicable for the tasks, situations, purposes, or users that the chatbot is designed for. In some cases, one or more custom instructions are appended or otherwise included with the user prompt 170 in the first request 172.

Many AI/ML models 132, such as LLMs, operate in a substantially stateless manner, in which a general model 132 does not automatically include context of previous interactions or specific knowledge about the chatbot being used. In addition, the chatbots provided by the computer system 110 do not need to have a one-to-one relationship with the AI/ML models 132. For example, a single model 132 may serve as the model for many different customized chatbots that are created and hosted using the computer system 110. Creating and customizing a chatbot does not require training or updating an AI/ML model 132, and instead can define parameters of the chatbot experience that are separate from the AI/ML model 132 (e.g., LLM) itself (e.g., parameters such as the data set used, the custom instructions provided with user prompts, whether Internet data can be used, the format and preferences for answers, and so on).

In order for the AI/ML model 132 to be able to appropriately answer the first request 172 and provide data processing instructions to answer the prompt 170, the computer system 110 can include with the request 172 information about the data set 122a and the database system 120. For example, the first request 172 can include metadata about the structure and type of content of the data set 122a, without including actual data of the data set 122a. For example, the metadata may include a database schema, a description of the data objects available from the data set 122a (e.g., logical data objects such as metrics, attributes, facts, etc.), an identification of data set 122a components (e.g., tables, columns, etc.) and a description or classification of semantic meaning of those components, and so on. The request 172 may also include sample data, such as a few rows of data or fictitious computer-synthesized data that is of the same type and structure as the data set 122a, but does not include the actual values from the data set 122a.

For example, the first request 172 can indicate the types of data in the data set 122a, and/or include a sample row or rows of data from the data set 122a, potentially using synthetic data to avoid revealing data of the data set 122a. The request 172 can also include information about the capabilities of the database system 120 and the data processing functions and manipulations that are available. For example, the request 172 can include instructions or description how to interact with the database system 120 to perform various processing functions, such as commands for sorting, filtering, joining, and otherwise manipulating data. In some cases, this information may include text of a user manual or other human-readable text describing the use of the database system 120. As another example, the request 172 can include a table of available commands for manipulating data in the database system 120, an API description for the database system 120, a list of valid interactions and their effects, or other data.

The request 172 can include a data model that includes information about the data set(s) that the chatbot will use to respond to the request 172, without including actual data from the data set. For example, the data model can include a data schema for the data set 122a. In general, the data model can indicate a list of logical objects represented in the data set 122a, such as a list of the elements or components of the data set. For example, the data model can indicate that the data set 122a includes logical objects such as date, customer identifier, region code, sales amount, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model can indicate the attributes and metrics that are available for the AI/ML model 132 to work with, and potentially additional attributes or metrics that can be generated or operations that are available for the database system 120 to create new attributes or metrics.

In some cases, the data model can indicate, through the logical objects identified, types of data from tables, columns, and other elements that make up the data set 122a, in addition to or instead of the semantic meanings and/or relationships among these elements of the data set 122a. For example, the data model can indicate that the data set 122a includes set of data named “sales_table,” that includes a metric named “sales_amount” that indicates amounts of sales and another attribute named “region” that indicates the region in which the sale occurred. These quantities may or may not correspond directly to the structure of the data set 122a. For example, the item “sales_table” may be an actual data table of a database, or may not represent a table and instead another grouping of data. Similarly, the “sales_amount” and “region” objects may correspond to specific columns of a data table, but may alternatively represent values that can be calculated or otherwise derived from the data set 122a in another way. Providing the data model can give the AI/ML model 132 a list and description of the logical objects that the database system 120 recognizes. As a result, the AI/ML model 132 can generate code or instructions that reference these logical objects that are understood by the computer system 110 and the database system 120. To the extent that the objects indicated in the data model differ from the actual structure of the data set 122a, the computer system 110 and the database system 120 can use convert from the logical object names used in the data model to actual data set elements and functions.

The data model can indicate the names or labels for these data elements, classifications of the elements (e.g., metric, attribute, etc.), and other information. In some implementations, the data model can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model can be provided in any of various forms, such as a database schema from a database management system, a list or definitions of objects, components, or identifiers of the data set 122a, etc.

By providing the data model with the request 172, the computer system 110 provides the AI/ML model 132 the ability to make use of the logical objects specified in the data model. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In addition, access control restrictions can be taken into account to adjust which data can be used. For example, the computer system 110 can generate the request 172 so that the AI/ML model 132 does not use or rely on portions of the data set 122a that the user 132 does not have authorization to access. For example, the data model provided with the request 172 can be a modified version of the data model for the data set 122a that identifies only the logical objects or portions of the data set 122a that the user 105c is authorized to access, and excludes portions of the data set 122a that the user 105c is not authorized to access. As a result, the AI/ML model 132 will not be aware of data sets or data objects that should not be accessed on behalf of the user 105c.

If the chatbot has been configured to use other knowledge assets, such as the one or more knowledge bases 147, the computer system 110 can include some or all of those knowledge assets in the request 172. In some implementations, the knowledge base(s) 147 that have been specified for the chatbot to use are included in their entirety with the first request 172.

In some implementations, the computer system 110 can perform or coordinate a selection or retrieval process to identify a subset of the knowledge asset content that is relevant to the prompt 170. For example, the computer system 110 can perform keyword matching to identify portions of a knowledge base 147 that match terms of the prompt 170. As another example, portions of the knowledge bases 147 or other knowledge assets can be selectively retrieved using semantic similarity. For example, the knowledge bases 147 can be entered in a vector database and represented with embeddings or positions in a high-dimensional vector space. The computer system 110 can represent the prompt 170, or separate chunks or portions of the prompt 170, in the vector space and identify the portions of the knowledge bases 147 that are relevant the prompt.

The process of retrieving knowledge base content can be one of multiple retrieval-augmented generation (RAG) retrieval steps. For example, one retrieval or selection step can be used to select content from one or more knowledge assets to be provided to the AI/ML model 132 with the first request 172. As discussed below, the response of the AI/ML model 132 can then be used to retrieve data from the data set 122a (e.g., as done by the database system 120), which can be a second RAG retrieval step.

In addition or as an alternative to providing other knowledge asset content, the computer system 110 can select content from the semantic graph 150 to include with the request 172. The semantic graph 150 represents a source of knowledge that can be applied to a variety of prompts. Generally, the semantic graph 150 is large for an organization and, for any given prompt, the semantic graph 150 includes many elements that are not relevant to the prompt. As a result, the computer system 110 can identify entities and relationships relevant to the prompt 170 as an initial step, and extract information about those entities and the entities they are connected to in the semantic graph 150. For example, the computer system 110 can identify a small sub-network from the semantic graph, as a small knowledge graph of elements related to or connected to terms, entities, or data objects referenced in the user prompt 170. With this information, the computer system 110 can improve its interpretation of both the prompt 170 and the other knowledge assets, such as the knowledge bases 147.

The first request 172 can be generated or adjusted based on information in the long-term memory 148 or other information about the user. For example, given the user interactions or feedback received through prompt-response cycles with the user 105c and/or other users, the long-term memory 148 may include information that can clarify what users intend when they ask a question as indicated in the prompt 170. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106c, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 170. The computer system 110 can provide the user context data 156 and conversation history 157 for the user 105c in or with the request 172, so the AI/ML model 132 can generate data processing instructions with the context of the user's situation and previous conversations, which may better explain or help disambiguate the most recent prompt 170.

In stage (G), the AI/ML service provider 130 uses the AI/ML models 132 to generate a response to the first request 172. The AI/ML service provider 130 then sends the response, a set of data processing instructions 174, to the computer system 110. As discussed above, the first request 172 requests instructions specifying the processing operations that the database system 120 can use to retrieve and/or generate (e.g., calculate) from the data set 122 the result data that would be needed to answer the user prompt 170. As a result, the AI/ML service provider 130 uses the AI/ML models 132 to generate the data processing instructions 174 that, when executed by the database system 120, will retrieve and/or generate the data needed to answer the prompt 170. In this process, the system 100 leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on.

In stage (H), the computer system 110 uses the received data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data. In some implementations, the computer system 110 may apply a set of rules or validation checks to verify that the data processing instructions 174 are valid and appropriate to be executed by the database system 120. For example, the computer system 110 can store rules or heuristics 152 that can evaluate the data processing instructions 174 element by element and/or as a whole to verify and correct the data processing instructions 174 if needed before they are sent to the database system 120. In some implementations, the computer system 110 uses the rules or heuristics 152 to convert or transform the data processing instructions 174 from one format or type to another.

When interacting with the AI/ML service provider 130 and/or the database system 120, the computer system 110 can apply the customized settings and properties that the administrator 103 defined for the chatbot. For example, the administrator 103 can limit which portions of the data set 122a can be accessed by the chatbot, and so the computer system 110 can apply those limits so that the first request 172 to the AI/ML service provider 130 does not reference omitted data (e.g., excluding from the description of the data set 122a columns or tables that are not to be referenced, so the AI/ML models 132 cannot use them or even determine that they exist). Similarly the first request 172 can include instructions to specifically exclude or avoid using certain data. In addition, or as an alternative, the computer system 110 can filter, edit, or otherwise check the data processing instructions 174 so that the operations specified do not draw from or become calculated based on excluded data. In addition, or as an alternative, the computer system 110 can analyze the results 176 to verify that the results 176 do not include or are not based on the excluded data.

As another example, the computer system 110 can apply access control policies or custom behavior based on the identity or role of the user 105c issuing the prompt 170. Those custom behaviors can be reflected in the interactions of the computer system 110 to the AI/ML service provider 130, such as in the request 172, as well as in the interactions with the database system 120.

In stage (I), the database system 120 generates and sends results 176 that include the data retrieved from and/or generated based on applying the data processing instructions 174 for the data set 122a. The database system 120 processes or executes the data processing instructions 174 that it receives, which creates the results 176, which may be in any of various forms, such as records retrieved, data series, aggregations of data, statistics about data in the data set 122a, subsets of the data set 122a determined to be relevant, and so on.

In the illustrated example, the user prompt 170 asks which regions have the greatest revenue over the last year. The data processing instructions 174 generated by the AI/ML models 132 specify the operations needed to generate measures of revenue by region for the previous year. For example, the data processing instructions 174 may include a SQL statement to retrieve these values, or may include a set of instructions in a programming language, such as Python. The results 176 generated by the database system 120 include the values needed to answer the question in the user prompt 170. In other words, the results 176 include values of revenue for the regions specified in the data set 122a, appropriately labeled or associated with identifiers for those regions. In this process, the AI/ML models 132 have been leveraged to obtain the results 176, however, the AI/ML models 132 did not need or receive access to the data set 122a itself, and the AI/ML models 132 did not incur the resource costs of having to process the data set 122a. In addition, the database system 120 and its reliable, repeatable calculations ensure that the results 176 are accurate, without the AI/ML models 132 introducing uncertainty into the calculations.

In addition, the data set 122a may be very large, much larger than the maximum context length of an LLM used for the AI/ML model 132. In many cases, the amount of data in the data set 122a may be orders of magnitude larger than the maximum context size that the LLM can process. The database system 120 can process a large data set much more quickly and with greater power efficiency than an LLM can. Due to limits on LLM context sizes, it may be impractical or impossible for an LLM to analyze the data set 122a to generate the needed results 176.

In stage (J), the computer system 110 sends a second request 178 to the AI/ML service provider 130. The second request 178 includes the results 176 and requests that the AI/ML models 132 generate a summary or other text response that answers the prompt 170 based on the results 176. For example, the second request 178 may be a request to answer the prompt 170 using the data in the results 176 as context. As another example, the second request 178 may be a request for the AI/ML models 132 to summarize the results 176, in addition to or instead of answering the user prompt 170. The second request 178 can also include one or more custom instructions that the administrator 103 specified, to further orient the AI/ML model 132 to respond in the format and with the content that is most applicable for the data set 122a and/or the overall purpose for which the chatbot was designed (e.g., customization for a particular organization, set of users or user roles, set of tasks, etc.). In some cases, one or more custom instructions are appended or otherwise included with the user prompt 170 in the second request 178. The second request 178 can also include one or more knowledge assets that are specified for the chatbot in the configuration data 146, such as one or more knowledge bases 147 that the administrator 103 specified to be used by the chatbot. In addition, content of the semantic graph 150 that is determined to be relevant to the prompt can also be included.

As with the first request 172, the computer system 110 can provide the user context data 156 and conversation history 157 for the user 105c in or with the second request 178, so the AI/ML model 132 can generate a response based on the context of the user's situation and the user's previous conversations, which may better explain or help disambiguate the most recent prompt 170. The computer system 110 can also provide information from the long-term memory 148 that the computer system 110 determines to be relevant, potentially as determined to be relevant specifically to the user 105c, the user context data 156, and/or the prompt 170.

In some implementations, the chatbot is configured to generate visualizations as part of the response to a user prompt 170. To create these visualizations, the computer system 110 can include in the second request 178, or as an additional request, a request for the AI/ML models 132 to indicate an appropriate type and format of visualization for the response to the request 178. The AI/ML models 132 can then be used to specify the parameters for the visualization, such as the type of visualization (e.g., line chart, bar chart, line graph, geographical map, heat map, etc.), and identification of which data items are shown on different axes or dimensions of the visualization, the ranges to show, the labels to use, the color scheme, and or other properties.

In stage (K), the AI/ML service provider 130 uses the AI/ML models 132 to generate a response to the user prompt 170, e.g., a summary 180 of the results 176 or other response requested by the second request 178. For example, the second request 178 may include or provide access to the results 176 and the user prompt 170, and so the AI/ML models 132 answer the prompt 170 from the context provided by the results 176. In some implementations, this may be a summary of the results 176 and/or may include values extracted from the results 176 with added text description generated by the AI/ML models 132.

For example, in the illustrated example, the AI/ML models 132 indicate the specific regions having the greatest revenue, as requested by the prompt 170, along with an indication of the revenue values taken from the results 176, along with other description and contacts. If the request 178 requests information about a visualization, or if the AI/ML models 132 determine that a visualization is likely appropriate or beneficial, then the summary 180 can include a visualization description. The visualization description can specify the properties recommended for a visualization of the results 176 as a whole, or for specific items that answer the user prompt 170.

In stage (L), the computer system processes the summary 180, and generates and sends a response 182 as the answer of the chatbot to the user prompt 170. The response 182 is then displayed on the user interface 162 of the client device 106c. The computer system 110 can process the summary 180 to create the response 182, for example, by applying customized settings or policies specified in the saved chatbot configuration data 146. In this way, the computer system 110 can apply customized style, formatting, content preferences or restrictions, and other customizations that were defined by the administrator 103. In addition, or as an alternative, the computer system 110 can incorporate those customizations when making the request 178. For example, the computer system 110 may include in the request 178 preferences for a concise or verbose answer, the tone or style of text used, and other preferences.

When a visualization is requested by the prompt 170 or suggested by the AI/ML models 132, the computer system 110 uses the visualization description from the AI/ML models 132 to generate the actual visualization content. In this manner, the visualization that is provided is based on reliable, accurate data or calculations in the results 176 and/or the data set 122a. For example, the visualization that is rendered has the type of data specified by the AI/ML model 132, and in the arrangement specified by the AI/ML models 132, but with values or data series shown being determined through data retrieval and/or calculations of the database system 120 to ensure accuracy and reliability.

Through any and all of the interactions of the computer system 110 to generate and provide the response 182, the computer system 110 applies the settings and properties specified in the saved chatbot configuration data 146. As a result, the behavior and characteristics that the administrator 103 specified for the chatbot can be enforced at any or all stages of the process to provide the customized interface and chatbot behavior that the administrator 103 desired.

FIG. 2A is a diagram showing an example of knowledge base content 200. For example, the knowledge base content 200 in the example includes descriptions and definitions for an organization, provided as entries in a spreadsheet file. Similar content can be provided in other forms, such as a text document.

As an example, the content 200 includes a statement 201 that “PESSC stands for Peakon Employee Satisfaction Score,” and another statement 202 “PESSC score of rating 4 and below means the employee is not satisfied or needs attention.” A chatbot that receives question about employees, or which access a data set about employees, can be configured to process the knowledge base content 200 as context for an LLM, so that the information in the knowledge base content 200 is consistently present when the LLM processes user prompts. In this manner, knowledge assets can instill a form of long-term memory to allow more meaningful interactions with users. The knowledge assets can bridge the knowledge gap between users and AI/ML models 132 by providing the AI/ML model with a deeper understanding of general knowledge, simulating long-term memory. This can be done using Retrieval Augmented Generation (RAG), to retrieve some or all of a knowledge asset to use as context for an AI/ML model 132.

In some implementations, portions of the knowledge base content 200 can be stored in a vector database, in which knowledge items are stored in association with a vector embedding in a high-dimensional space. The vector embedding represents topics or concepts of the knowledge item. When a user prompt is received, one or more query vector embeddings can be generated from the user prompt. The system can then retrieve the knowledge items that have vector embeddings that are nearest (and thus most relevant to) the query vector embeddings. The system can assign scores to knowledge items indicating the similarity of their corresponding stored vector embeddings to the query vector embeddings, and then select a top-ranking portion (e.g., top 5 items, top 10 items, etc., or top 5%, top 10%, etc.) of the knowledge items to be provided to the AI/ML model 132 to use when generating a response to the user prompt. In this manner, the system can identify and selectively provide the portions of knowledge base content 200 that are most relevant to the particular user prompt being processed.

Administrators can upload knowledge assets like business glossaries, industry terminology, and relevant definitions to allow chatbot responses tailored for an organization and its specific terminology. The content can be provided in the form of a spreadsheet, text document, or other form. In many cases, knowledge assets can focus on information that directly supports typical inquiries, and can steer clear of including general rules or overly broad concepts that may be vague or difficult to apply.

FIGS. 2B-2E are diagrams showing examples of user interface for chatbots.

FIG. 2B shows a user interface 210 for interacting with a chatbot. The user interface 210 includes a welcome message from the employee chatbot as well as suggested questions that the user can select. User interface 210 also includes a text input field 212 in which the user has entered a prompt 214, “How many employees need attention?”

FIG. 2C shows an example in which the chatbot does not have access to the knowledge base content 200, and so cannot provide an answer to the user's question. The example includes a user interface 220 where the chatbot has provided a response 226 to the user's prompt 214. However, because the chatbot did not have access to the knowledge base content 200, the chatbot (including the AI/ML model 132 used) did not know how to interpret the what “need attention” means. Without the criteria needed, the response 226 indicates the failure of the chatbot to answer the question, with the statement “I'm sorry, but I can't provide the information you're looking for because the dataset doesn't contain a specific column that indicates whether an employee needs attention or not. Could you please specify the criteria or conditions that determine if an employee needs attention? For example, it could be based on their performance score, growth rate, or other factors.”

As discussed above, the processing performed for generating a chatbot can include a first series of interactions with a AI/ML model 132 that generates data processing instructions for retrieving data from the database system 120. Without the knowledge based content 200, the chatbot in this example was unable to formulate an effective set of instructions (e.g., a SQL statement) that would retrieve data that could answer the user's prompt. In fact, the AI/ML model 132 was unable to identify the logical data objects or components of the data set that would be relevant to the question. As a result, the RAG stage of retrieving data from the database system 120 was ineffective, and so the second stage of interaction to answer the user's question was also ineffective.

FIG. 2D shows an example in which the user asked the same question to the chatbot, but in this example the chatbot had access to the knowledge base content 200 and could provide the requested information in a chatbot response 238. In further detail, the user prompt 214 asks how many employees need attention. The knowledge base content 200 shown in FIG. 2A includes the statement 202 which provides the criteria for judging whether an employee needs attention, e.g., a PESSC score of four or less needs attention. The knowledge base content 200 also includes the statement 201 that provides the meaning of the abbreviation PESSC. With these pieces of information provided as context with the user's prompt 214, the AI/ML model 132 can identify the logical data objects of the data set that can provide the PESSC score.

The information in the knowledge base content 200 thus provides the links or connections needed for the AI/ML model 132 to reference the data object represents the PESSC score, and which can be used to retrieve data from the PESSC score column of a table in the appropriate data set. Then, because the appropriate logical data object is referenced, the data processing instructions (e.g., SQL statement, Python code, etc.) that the AI/ML model 132 generates in the first round of interaction to answer the prompt 214 includes valid references to the type of data needed. Because this link to the proper data object in the data set is provided, the database system 120 provides the needed data, such as the identifiers and scores for users having a PESSC score of four or less, and the AI/ML model 132 can use that retrieved data to generate and provide the information in the response 238.

FIG. 2E shows another example user interface 240 in which the chatbot is able to use the information in the knowledge base content 200 to provide an accurate response 238 to the prompt 214. The interface 240 also shows interpretation content 242 demonstrating how the AI/ML model 132 interpreted the user's prompt 214. For example, the interpretation content includes a natural language summary that states that the prompt “How many employees need attention?” was interpreted as “Count the number of employees needing attention with a PESSC score of 4 or less.” This interpretation demonstrates how the chatbot was able to incorporate the meaning or definition of what it means to “need attention” from the statement 202 in the knowledge base content 202. By displaying the interpretation content 242, the user interface 240 also shows the user the definition used.

In addition, the interpretation content 242 specifies the data objects or data set components used in generating the data used to answer the prompt 214. For example, it shows that an attribute “ID” was used, which represents an employee identifier. Also, a new metric is specified as “employees needing attention” which attempts to count distinct employees, and that a filter criterion or selection criterion of “PESSC <=4” is applied. As a result, the interpretation content 242 show how the chatbot used the “ID” attribute, and then found distinct “ID” values associated with a PESSC score of four or less to arrive at the answer presented in the response 238.

In some implementations, the interpretation content 242 is obtained by analyzing or processing the data processing instructions that the AI/ML model 132 produces. For example, the response to the first request to the AI/ML model 132 for generating data processing instructions can be a SQL statement that specifies data to retrieve, such as to retrieve the set of employee IDs having PESSC scores of 4 or less. From the SQL statement, the computer system 110 can identify or extract the data objects referenced, e.g., the metrics, attributes, as well as operations or other instructions, e.g., expressions or equations, filter criteria, sorting criteria, etc. That information can then be provided as the set of components used. In addition, the computer system 110 can send the data processing instructions that the AI/ML model 132 created back to the AI/ML model 132, along with an instruction to provide a concise natural language statement summary. In other words, the computer system 110 can request for the AI/ML model 132 to convert or translate the SQL statement into an actual language summary, which can then be provided in the interpretation content 242.

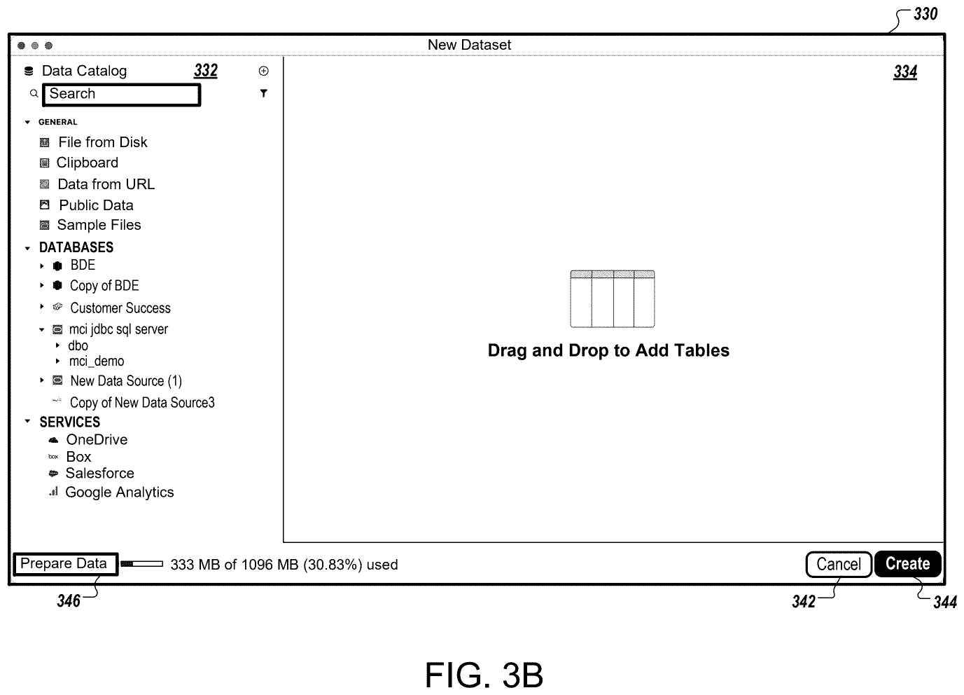

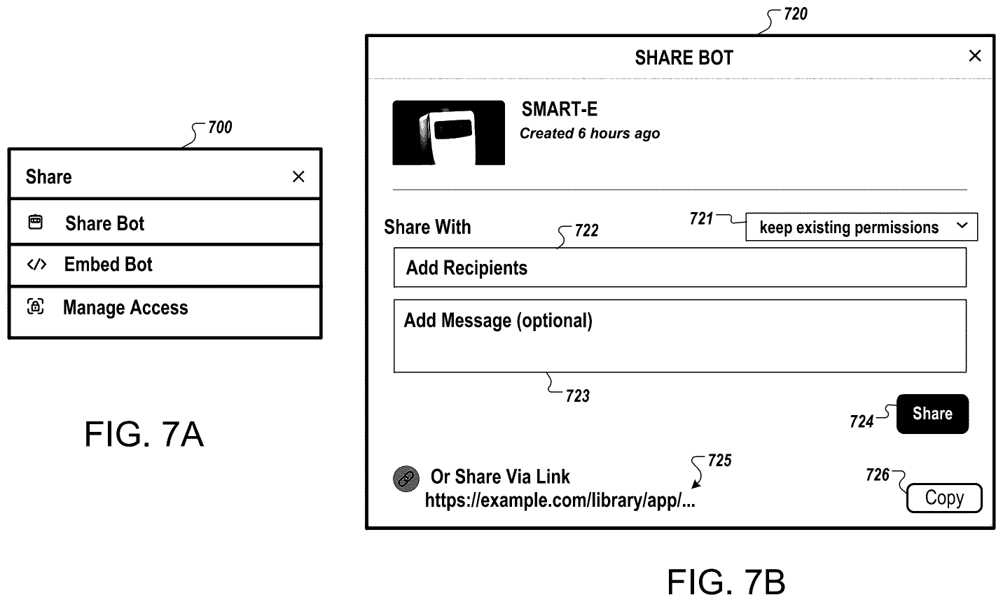

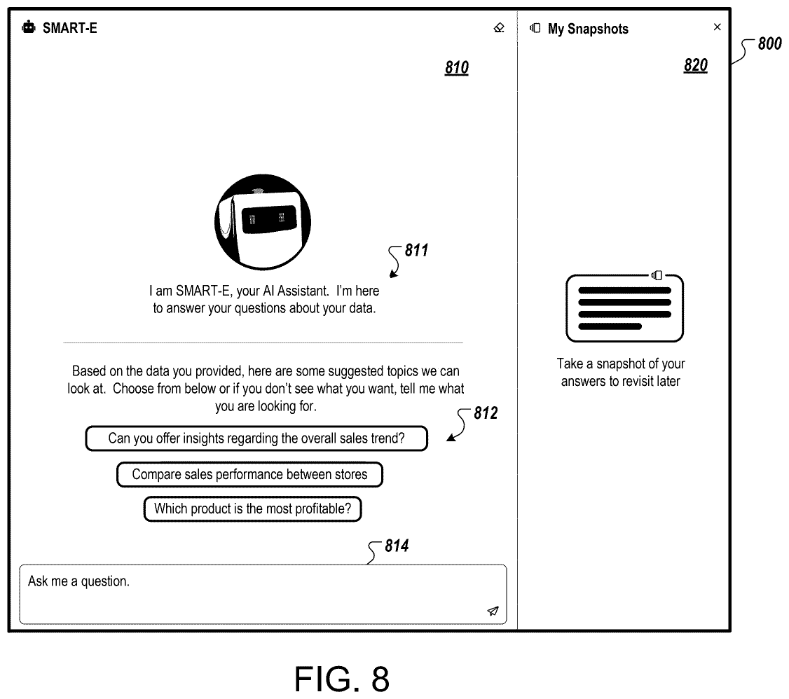

FIGS. 3A-13 illustrate various user interfaces for creating, sharing, deploying, and using chatbots. FIGS. 3A-6E show interfaces that the administrator 103 can use to create or edit a chatbot with customized characteristics and behavior. FIG. 7A-7B illustrate interfaces for sharing a customized chatbot. FIG. 8 shows an example of a user interface for interacting with the customized chatbot.

FIG. 3A shows an example of a user interface 300 that the administrator 103 can use to create a new chatbot or other AI/ML-powered interactive application. The interface 300 includes a control 302 for the administrator 103 to select an environment or category in which the new chatbot will be made available. The user interface 300 also includes a data selection area 310 that includes a variety of controls enabling the administrator 103 to specify the data set(s) that the new chatbot can access and use. In some implementations, the chatbot is based on a single data set or collection of data sets that is specified in advance when the chatbot is created. In many cases, it is helpful for administrators to create separate chatbots based on different data sets and to customize the appearance and behavior of each chatbot specifically for the set of users or type of tasks that the chatbot will be used with.

In some implementations, the administrator 103 creates a chatbot to answer questions about a specific set of data, such as a specific spreadsheet or data collection that is static and unchanging, e.g., a fixed set of data. In other implementations, however, the data set(s) specified may grow and change and be updated over time, and the chatbot will interact and provide data based on the most recent contents or state of those data sets. The database system 120 and the new customized chatbot will be able to take advantage of new and updated data in the selected data set, using the most recent, up-to-date contents each time a new user prompt is submitted. In other words, selecting a data set can specify the data source that the chatbot will look to for generating responses and answers to user prompts, but the answers the chatbot provides in the future can be based on the contents of the data set at the time of the request.

This can allow the chatbot to avoid issue of “knowledge cutoff,” where an LLM does not incorporate any information about events or facts after its training is complete, and the issue of limited context size, both of which are significant limitations for many LLMs. Typically, an LLM only has information about, and can only answer based on, information observed through training or provided as context (e.g., in or with a user prompt, or prior history in the conversation). As discussed above, the size allowed for context is limited and the training state is fixed at some point in time and cannot include more recently generated information. Nevertheless, in the present system, the database system 120 can generate results 176 based on current, up-to-date data in the data set 122a, without the AI/ML models 132 needing to be trained on that data or enter that data as context. The results 176 can then be entered as context for the second request 178, which limits the amount of context that the AI/ML model 132 needs to process (e.g., the results 176, not the full data set 122a or sections of the data set 122a).

Referring still to FIG. 3A, the data selection area 310 includes a table 312 showing a list of data sets that are available to the administrator 103. For example, the table 312 shows a number of files, data cubes, data tables, or other data collections listed by name. The table 312 also indicates other properties of the data sets, such as whether the data set is certified, who the owner or creator of the data set is, a date of the most recent modification, and a creation date. The data selection area 310 includes controls, such as check boxes, that the administrator 103 can interact with to select one or more data sets for the new customized chatbot being created.

The interface 300 also includes a button 320 that, when selected, allows the administrator 103 to create a chatbot with new data, such as by importing or creating a new data set, rather than using one of the existing data sets from the table 312 as the basis for a chatbot. The interface 300 also includes a control 324 to initiate creation of the chatbot based on the selected data sets. The interface 300 also includes a cancellation control to 322 that will cancel the chatbot creation process if selected.

To assist the administrator 103 in finding the desired data sets, the interface 300 includes a search field 314 that the administrator can enter a keyword or query in to search among the existing data sets available to the administrator 103. The interface 300 can also include a variety of filter controls for narrowing the set of data sets shown, such as a control 316 that can be selected to limit the data sets shown to those that have been certified.

FIG. 3B shows another example of a user interface 330 for specifying the data to be used by a chatbot. For example, the user interface 330 is an example of an interface that can be shown after the administrator 103 selects the control 320 (FIG. 3A) to create a chatbot with new data. The interface 330 allows the administrator 103 to create a data set as an aggregation of data, from existing data sources already present in the database system 120 and/or through importing outside data sources.

The user interface 330 includes a data catalog 332 showing a variety of sources of data available to the administrator 103, such as files from disks, clipboard contents, data from URLs, public data, sample files, databases, or third party services that provide storage. The data sources made available from the data catalog can include locally stored data, as well as remotely storage data from, for example, a company network, a cloud computing service, and other data providers. The data catalog 332 enables the administrator 103 to browse and select data sets, and/or to search and filter existing data sets to find and select appropriate data for creating the chatbot.

The user interface 330 also includes a drop area 334, where a user can drop tables or other data sources to include them in the scope or set of available data for the chatbot being created. For example, after browsing the data catalog 332 or searching the data catalog through to, the user can drag items found from the data catalog panel to the drop area 334 to select them for use by the chatbot. And some implementations, the collected set of data sets that the administrator 103 drags and drops to the drop area 334 can be combined or specified as the collection that the chatbot can access.

In some implementations, the drop area through four or a similar area enables the administrator 103 to drag and drop files or other data from outside the data catalog 302 in order to import new data sets. For example, the administrator 103 may drag and drop a spreadsheet or database file on the drop area 334 to initiate importing of the data and selection of that data for use by the chatbot.

The user interface 330 includes a control 346 that enables the administrator 103 to prepare or refine the data set to be used by the chatbot. The interface 330 also includes a control 344 to initiate creation of the chatbot based on the data set selected or created using the interface 330. The interface 330 also includes a cancellation button 342 to cancel the creation or importing of a new data set.

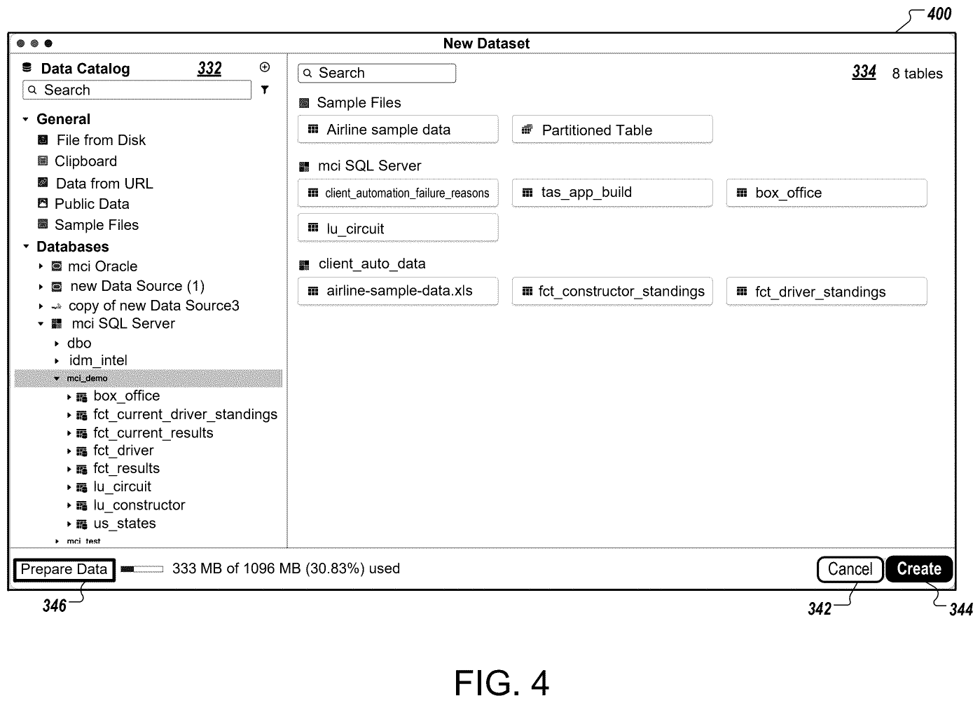

FIG. 4 shows another example user interface 400 that the administrator 103 can use to specify the data that the chatbot will be able to use. In the example, the administrator 103 has dragged a number of files and data sources from the data catalog 332 to the drop area 334. As a result, the drop area 334 has been updated to show the files and tables that, together, will form the data set that the new chatbot can access. In this case, there are nine items shown, organized into three categories based on the relationships of those data sources. When the administrator 103 is satisfied with the collection of data specified, the administrator 103 can select the control 344 to proceed with creation of the chatbot, or may select the control 346 to prepare the data set further.

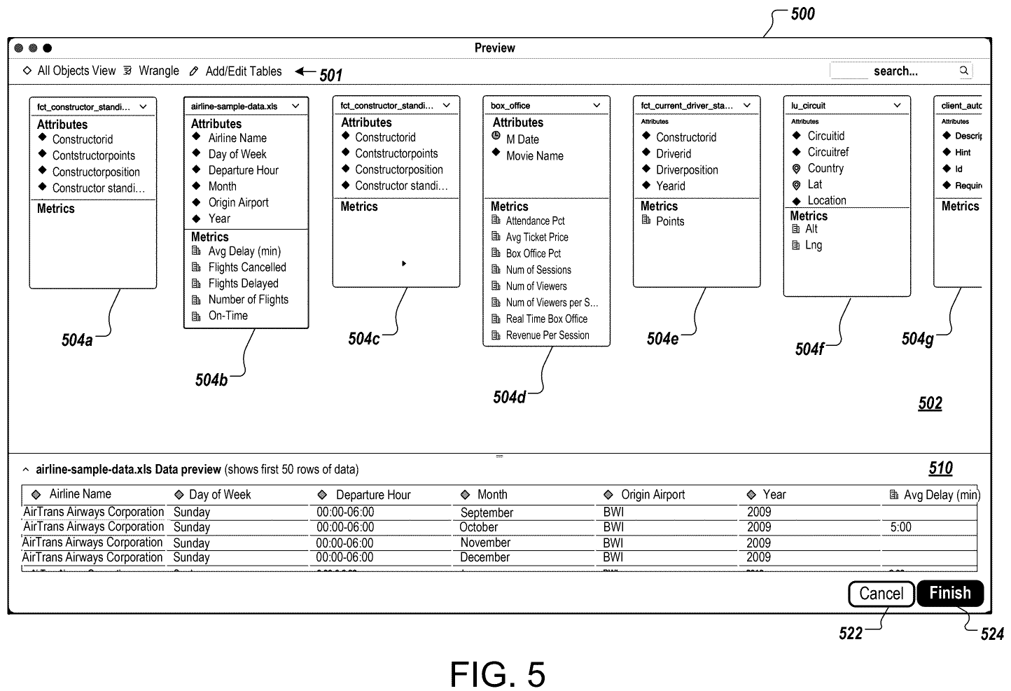

FIG. 5 shows another example user interface 500 that the administrator 103 can use to prepare data before finalizing the data set for the new chatbot being created. For example, the system can provide the user interface 500 to the administrator 103 after the administrator 103 interacts with the control 326 that initiates the data preparation process.

The user interface 500 provides controls that can initiate various operations for preparing the data set for the chatbot. For example, a number of controls enable an administrator 103 to add or edit tables, wrangle data by standardizing, filtering, joining, or otherwise manipulating the data.

The user interface 500 includes an object view area 502 that shows the objects in the data set and their properties. For example, after the administrator 103 has selected the tables shown in FIG. 4, each of those tables can be represented in the object view area 502 with an object representation 504a-504g. These object representations 504a-504g each indicate the attributes available in the corresponding data object, as well as metrics available. For example, the object representation 504b represents the airline-sample-data.xls spreadsheet file, and indicates that this object includes attributes of airline name, day of week, departure hour, month, origin, airport and year, as well as metrics average delay, flights canceled, flights delayed, number of flights, and on-time measure. The attributes and metrics for each of the other data objects are also provided. More generally, the interface 500 can indicate the structure and contents of data sets, by providing information about the data, schema, dimensions or data types included, and so on.

The interface 500 also includes a data preview area 510, which shows example records or rows from a selected object. For example, when the administrator 103 selects the object representation 504b, the system populates the data preview area 510 with the sample rows of data shown.

These are interface 500 also includes a control 522 to cancel the data preparation and data preview, as well as a finish control 524 to finish the data preparation and continue with creation of chatbot.

FIG. 6A shows another example user interface 600 that the administrator 103 can use to specify properties and behavior of the new customized chatbot. For example, after the administrator 103 has specified the data set to be used by the chatbot and the administrator 103 has made any changes or updates desired to prepare the data set, the interface 600 can be displayed so that the administrator 103 can edit the chatbot.

In some implementations, new chatbots are created with an initial set of default chatbot settings 154 as shown in FIGS. 1A-1B. The administrator 103 can change the settings of the chatbot using the interface 600 to alter or customize the settings to change the appearance and operation of the chatbot.

The user interface 600 includes two major areas, a chatbot preview area 602, and a editing interface 610. The preview area 602 provides a functional, interactive interface for the administrator 103 to view and test the chatbot during the editing process. For example, after the administrator 103 changes a setting using the editing interface 610, the changes to the appearance and operation of the chatbot are reflected in the preview area 602. This allows the administrator 103 to iteratively adjust and test the chatbot with different settings, with real-time or near-real-time feedback that indicates how changed settings affect the user experience for the chatbot.

The preview area 602 provides a chatbot interface 603 and a snapshot region 604. In the chatbot interface 603, and icon or image for the chatbot is shown as well as an initial message to the user. In addition, the chatbot interface 603 includes automatically generated suggestions 605 of user prompts that can be selected in order to request a response. In addition, the chatbot interface 602 includes a text input field 606 for the administrator to type or otherwise enter a user prompt to the chatbot. The snapshot region 604 shows previous responses of the chatbot that have been saved for later viewing. The editing interface. 610 includes a number of tabs or areas with controls for specifying different categories of settings. For example, a general settings tab 620 is shown, which includes controls that enable the administrator 103 to specify general properties of the chatbot interface 603 that users will see. For example, the general settings tab 620 includes a text field 623 in which the administrator 103 can enter or edit an initial message that the chatbot provides to users. This message is shown in the preview area. 602, demonstrating how settings specified in the editing interface. 610 are applied to show the effect in the preview area of 602. As another example, a control 628 enables the administrator 103 to specify the number of automatically generated suggestions that are shown to users. The current selection of three automatically generated suggestions is shown in the preview area 602 as three suggestions 605.

FIGS. 6B-6E show tabs or regions of the editing interface 610 in greater detail.

FIG. 6B illustrates the general settings tab 620 in further detail. For example, the general settings tab 620 includes a text field 621 for the administrator 103 to specify a name for the new chatbot. In addition, a control 622 enables the administrator 103 to toggle whether the chatbot is active or not, e.g., whether the chatbot can be used or accessed by other users. In addition, the general settings tab 620 includes a text field 623 to provide a greeting or initial message to users, as discussed above.

The general settings tab 620 also includes controls for the administrator 103 to enable or disable other chatbot features. For example, the control 624 sets whether or not users will be able to save responses from the chatbot as snapshots, which can be displayed in a snapshot region 604. The control 625 enables the administrator 103 to specify whether the chatbot will be able to access data from the Internet to respond to user prompts. If disabled, as shown in the example, the chatbot will be limited to deriving responses from the data set that corresponds to the chatbot, and potentially content generated by the AI/ML models 132. If the control 625 is enabled, the chatbot will be permitted to access additional data sources from the Internet, such as public records or third-party web sites to answer user prompts. This can be helpful in the event that users ask for information that is not in the data set for the chatbot. On the other hand, limiting the data source from which the chatbot provides answers can help ensure the quality, relevance, and predictability of responses from chatbot.

The general settings tab 620 also includes controls that adjust how users provide user prompts to the chatbot. For example, a text field 626 enables the administrator 103 to specify a hint or instruction to users that can help the users know how to interact with the chatbot. In addition, a control 627 the specifies whether, the chatbot interface 603 provides suggestions, and a control 628 enables the administrator 103 to select how many automatically generated suggestions are shown. In addition, a control 629 enables custom suggestions to be added for display to users on the chatbot interface 603. In some implementations, the administrator 103 may desire to limit the rate that users submit questions and/or the total number of questions. Any given user can submit over a period of time. For example, The general settings tab 620 can include a control 630 for the administrator to specify a limit of how many questions each user can submit per month. The amount of computing resources required to perform inference using AI/ML The models 132 is significant, and may incur financial costs or result in congestion and delays. If not limited, administrator 103, they find a beneficial to impose reasonable limits to the number of user prompts or questions permitted. The general settings have 620 can also include an area for the administrator 103 to specify URLs or other references that can be helpful to users and which would be displayed on the chatbot interface 603.

FIG. 6C shows an example of an appearance settings tab 640, which includes controls that enable the administrator 103 to alter the appearance of the chatbot interface 603. For example, a control 642 and specifies whether the chatbot will be displayed in a panel or other region of a user interface. A control 641 enables an administrator to specify an image or logo for the chatbot by typing or pasting a URL for an image. Other controls adjust formatting, layout, another properties. For example, a panel theme control 643 enables the administrator to select from among different visual themes or styles to be used in displaying the chatbot interface 603. Similarly, a visualization palette enables the administrator 103 select from among multiple different color schemes that will be used in rendering visualizations provided by the chatbot, such as color schemes for charts, graphs, maps, and other visualizations.

FIG. 6D it provides an example of a custom instruction tab 660 for the administrator to specify custom instructions to an LLM and also to specify custom knowledge assets to be used by the chatbot. Unlike the text fields of the general settings tab 620, which were primarily concerned with text and instructions viewed by the user of the chatbot, the custom instruction relates to instructions to the database system 120 and/or AI/ML model(s) 132 (e.g., LLM(s)) used to generate responses to user prompts. Using the custom instruction settings, the administrator 103 can tailor the content, style, and other properties of responses produced by the chatbot. In addition, the custom instruction tab 660 here includes controls to allow the administrator to specify knowledge assets, such as a data dictionary, knowledge base, etc., that can be provided as a whole or in part to an AI/ML model with user prompts and other requests.

For example, the control 661 toggles whether the custom instructions are used in this chatbot or not. The control 662 is a text field to receive background information and context that will help improve the quality of responses from chatbot. For example, the administrator 103 can specify requirements about the data set or business background and purpose of the chatbot. For example, if the chatbot is designed for use by an accounting department and there are certain conventions or preferences for presenting those responses, the administrator 103 can specify it in the text field of the control 662. The instruction can be specified in any of various ways, including as an instruction to a LLM or as a general statement of the purpose or intent of the chatbot being created. The custom instruction that the administrator 103 specifies can be included in the requests that the computer system 110 sends to the AI/ML service provider 130, and which are ultimately acted on by the AI/ML models 132. As a result, the instruction can be included as context processed by the AI/ML models 132 when generating responses. In this manner, even though the AI/ML models 132 are not trained specifically for the current chatbot that is being created, and the same AI/ML models 132 may be used for multiple chatbots, the current chatbot still produces consistently customized responses through the consistent use of the custom instruction. In other words, even though the AI/ML model 132 used by the chatbot may not specifically trained for this chatbot used, the computer system 110 can implement the customization desired by a pending the customer instruction to requests for this chatbot. The custom instructions can be provided to the AI/ML models 132 once per conversation (e.g., at the beginning of each conversation), with each user prompt 170, repeatedly after a certain amount of context is built to keep the custom instructions in the context, or in another manner.

The custom instruction tab 660 also includes a text field control 663 in which the administrator can specify the format of responses that the chatbot should use. As with the custom instruction entered in text field control 662, the text can be provided with requests that the computer system 110 sends to the AI/ML models 132 for this chatbot, so that the text in the text field control 663 is included as context for, or even an extended part of, at least some user prompt that will be provided to this chatbot that the administrator 103 is creating or editing. For example, the administrator 103 can enter in the text field control 663 information about the format of responses, such as a preference for a list of values, a summary followed by a table, or other instructions about the style or format that generated text should take. This instruction can be included with user prompts and/or requests from the computer system 110 to the AI/ML models 132 for this chatbot.

The user interface 660 also includes a knowledge asset region 664 including a drop target area 665, where a user can drag and drop a file to add as a knowledge asset for the custom chatbot being created or edited. That's another example, the knowledge asset region 664 can include a button or other control to bring a file selection menu into view, so the user can select a file from a file system or library to be uploaded as a knowledge asset for the chatbot.

In some implementations, the user interface 660 can present a set of knowledge bases for the organization, so the administrator can select from among existing knowledge assets that were previously selected or uploaded. For example, the system 110 can identify files, data collections, rule sets, or other content that has been designated as a knowledge asset for one or more other chatbots for the same organization as the administrator. The administrator can then select from among these existing knowledge assets to add them as knowledge assets for the current chatbot. By re-using knowledge assets across multiple chatbots, the administrators can maintain consistency of interpretations across chatbots, and also import organization-specific or subject matter domain-specific information more efficiently. Associating the same set of knowledge assets with multiple chatbots can facilitate management and also efficient updating of information. All chatbots that are configured to use the same knowledge assets, e.g., linked to use the knowledge base, can be automatically updated as soon as the associated knowledge assets are updated. A single addition to a knowledge base in this manner can improve the capability of all associated chatbots.

In some implementations, the knowledge asset region 664 can be used to authorize semantic graph usage by the chatbot. If the administrator selects to allow use of the semantic graph, then the processing of queries can be accompanied with a retrieval augmented generation (RAG) step of deriving matches of semantic graph content (e.g., lists of objects, their attributes, and the objects to which they are connected) to portions of the user prompt. The results from the semantic graph can then be provided to the AI/ML models 132 (e.g., with the first request 172 and/or the second request 178), along with other knowledge assets, to enable the AI/ML models 132 to better interpret the user prompt and generate a response.

FIG. 6E shows an example of a data settings tab 680 that includes controls that enable the administrator 103 to manage the accessibility of the data in the data set used to respond to user prompts. In some cases, the administrator 103 may desire to limit the chatbot to using only a subset of the data in the data set to respond to user prompts. To achieve this, the administrator 103 can select, item by item, which types of data or sources of data to include or exclude from use by the chatbot. For example, the data settings tab 680 includes a list 682 of metrics, attributes, and other data items available in the data set for the chatbot, as well as check boxes that can be used to individually include or exclude that data item from use by the chatbot. This provides the administrator 103 fine-grained control over the chatbot's use of the data set. Using these features can also improve the relevance and quality of answers, because the administrator 103 can tailor the portions of the data set available to the chatbot to the tasks, context, and overall needs of the users that the chatbot is designed for.

The data settings tab includes a search field 681 to receive keywords or query terms to search among the data items of the data set for the chatbot, to allow the administrator 1032 more easily find and adjust the status of those data items. In addition, a context menu 683 or other region can include controls for editing, replacing, renaming, or otherwise changing the data set that the chatbot uses.

In addition to the types of settings shown in FIGS. 6A-6E, The editing interface 610 can provide controls to specify or change other aspects of the chatbots, appearance and operation. For example, additional controls can be provided to specify access control properties, such as to specify users or user groups that are included or excluded from accessing the chatbot. In addition, controls can be provided for the administrator 103 to specify authentication requirements, and other policies or preferences regarding the chatbot.

After the administrator 103 has specified the settings for the chatbot, and is satisfied with the appearance and operation as observed in the preview areas 602, the administrator 103 indicates the chatbot is complete. The computer system 110 then generates the chatbot, including by saving the chatbot configuration data 146 and registering the chatbot so it is accessible to users.

FIGS. 7A-7B illustrate examples of interfaces and options for sharing or distributing a chatbot to users after the chatbot is created.

FIG. 7A shows a context menu panel 700 or other user interface region that can be shown to the administrator 103, potentially from the user interface 600 or another user interface. For example, the panel 700 can include options that the administrator 103 can select to share the chatbot through an email message, text message, in-application message, addition of the chatbot to a set of available chatbots in a library or chatbot listing, and so on. As another option, the panel 700 enables the administrator 1032 select to embed the chatbot in a user interface, such as in a website, web application, or other user interface. In addition, the panel 700 provides the administrator 103 an option to manage access to the chatbot, such as by editing a list of users or user groups for whom the chatbot is available.

FIG. 7B provides an example of a user interface 720 that assists the administrator 103 to share the chatbot that was created. For example, the user interface 720 can be presented in response to the administrator 103, selecting the “share bot” option from the panel 700.

The interface 720 includes a control 721 that enables the administrator 103 to set the permissions that the recipient of the sharing message will have. For example, the administrator 103 can specify to increase, decrease, or keep the existing permissions of the recipients. The interface 720 includes a field 722 to receive identifiers for recipients of access to the new chatbot. For example, the field 722 can receive names, email addresses, or other identifiers, or may a trigger a selection interface for the administrator 103 to select from contact records of the administrators organization. The interface 720 includes a field 723 for the administrator 103 to specify a message to the recipients, as well as a control 724 to initiate sharing of the chatbot. Upon interaction with the control 724, the computer system can send messages via email, text message, in-app messaging, or other means to notify recipients of their access to the chatbot. In addition, or as an alternative, the chatbot may be shared in the form of updating a toolbar, homepage, document or object listing, or other interface to add the new chatbot as an object or option for the users to access. The computer system 110 also updates access control lists and other permissions related to the chatbot so that the recipients specified in the field 722 our granted appropriate access to use the chatbot.

As another option, the administrator can share access to the chatbot using a URL or other reference. For example, the interface 720 may provide a URL 725 for the chatbot, which may operate for anyone that uses the URL. The user interface 720 can include a control 726 to copy the chatbot access URL 725 to a clipboard or other interface to facilitate dissemination to other users.

FIG. 8 shows an example of the chatbot interface as it can be displayed on user interfaces of client devices 106a-106c of the users 105a-105c with which the chatbot has been shared. Similar to the preview area 602 of FIG. 6A, the user interface 800 includes a chatbot interface 810, in which the user enters prompts to the chatbot and the chatbot provides responses. In addition, the interface 800 includes a snapshot area 820 that shows chatbot answers that the user has saved and for the detail, the chatbot interface 810 includes the greeting 811 that the administrator 103 specified for the chatbot along with the name (“SMART-E”) and logo that the administrator 103 specified for the chatbot. In addition, the chatbot interface 810 includes three suggested user prompts 812 as the administrator specified.

The interface 800 of FIG. 8 demonstrates how a few of the settings that can be specified for the chatbot are carried through to the appearance and operation of the chatbot experienced by users. In addition, the customizations specified by the administrator 103 and saved in the saved chatbot configuration data 146 are also used to customize the content and format of responses generated and provided through the chatbot interface 810. For example, the chatbot provides answers based on the particular data set that the administrator 103 selected or generated using the features of the interfaces in FIGS. 3-5. In addition, the responses generated by the chatbot are limited to the subset of data from that data set as specified by the selections in the data settings tab 680 of FIG. 6E. In addition, interactions of the computer system 110 with the AI/ML models 132 can include or otherwise incorporate the information from the custom instructions specified in the custom instruction tab 660. For example, when the user 105c submits a question through a text field 814 of the chatbot interface 810, the computer system 110 can supplement or augment the user's question with the custom instructions, e.g., as additional prompt content or as context for the user prompt. In a similar manner, the computer system 110 can use the settings for the chatbot, as saved in the saved chatbot configuration data 146, to customize or create each interaction with the AI/ML service provider 130 and AI/ML models 132, with the database system 120, and with client devices 106a-106c. As a result, the saved chatbot configuration data 146 that captures the settings of the administrator 103 for the chatbot can be applied consistently and repeatedly for many users to provide a customized chatbot experience. In addition, other chatbots that use the same AI/ML models 132 and potentially even the same data set(s) have their own separate appearance, behavior, and content of responses, as specified by the respective saved configuration data for those chatbots.

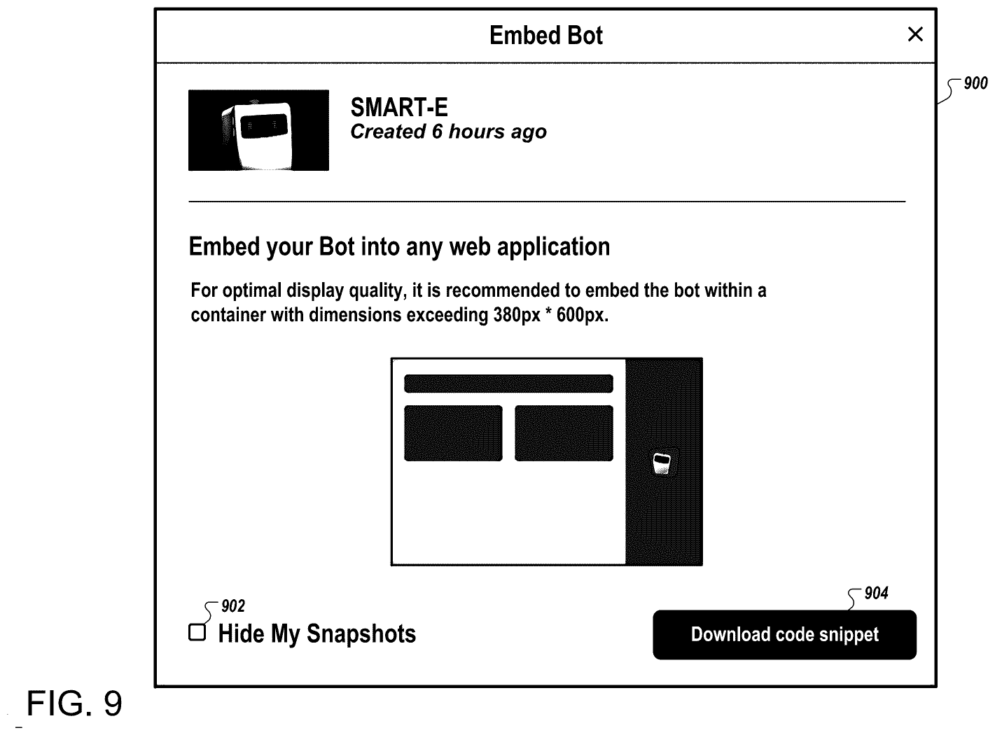

FIG. 9 shows an example user interface 900 explaining to the administrator 103 how the chatbot can be embedded in web applications. The user interface 900 explains that the recently created chatbot, named “SMART-E,” can be embedded into web applications, such as a container with at least certain minimum dimensions. The user interface 900 can provide controls for the administrator to specify settings for the chatbot when embedded, such as the checkbox control 902 to specify whether features for users to save and view answers from the chatbot, e.g., the “My Snapshots” feature, should be enabled in the embedded view of the chatbot interface. The user interface 900 has a download control 904, such as a button, that the administrator 103 can interact with to obtain a code snippet (e.g., HTML code, JavaScript code, etc.) that will embed the chatbot interface into a region of a web page or web application (e.g., in a container, frame, iFrame, etc.). The computer system 110 generates the code snippet to provide the interface to the specific chatbot the administrator 103 is working with. The code snippet can include, for example, components such as a URL, size parameters, border or formatting parameter values, and parameter values setting other appearance or behavior (e.g., whether scrolling is allowed, etc.).

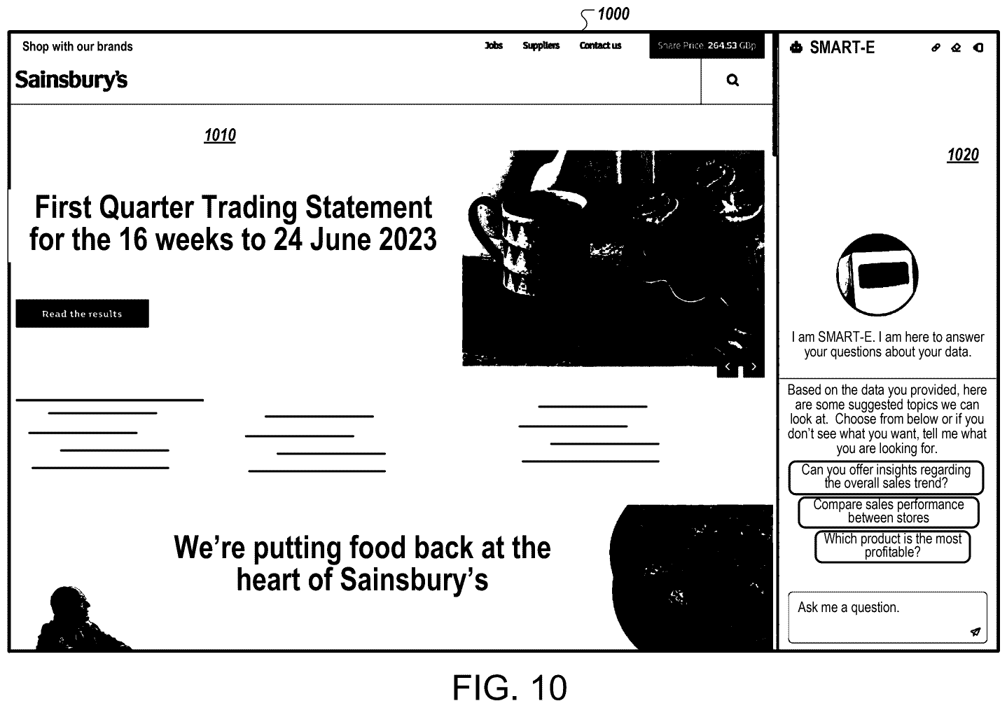

FIG. 10 is an example of a user interface 1000 in which the chatbot interface 1020 has been embedded in a web page 1010 or web application as an inline frame. When the main web page 1010 or web application is loaded, the chatbot interface 1020 can be automatically loaded in the designated area, as illustrated. In some implementations, the chatbot interface 1020 is not initially displayed upon loading of the web page 1010, but is instead expanded or invoked in response to a user interacting with a portion of the web page 1010, such as a button, icon, or message text designated to bring the chatbot interface 1020 into view.

In some implementations, the chatbot interface 1020 is provided in other ways, such as through an extension module or toolbar module for a web browser. For example, as an add-on module for a web browser, an icon can be displayed in the web browser interface, independent of the web page or web application that the user navigates to. The add-on module can be configured to display the chatbot interface 1020 alongside, or as an overlay over, any web page or web application being displayed, in response to a user interaction to present the chatbot interface 1020.

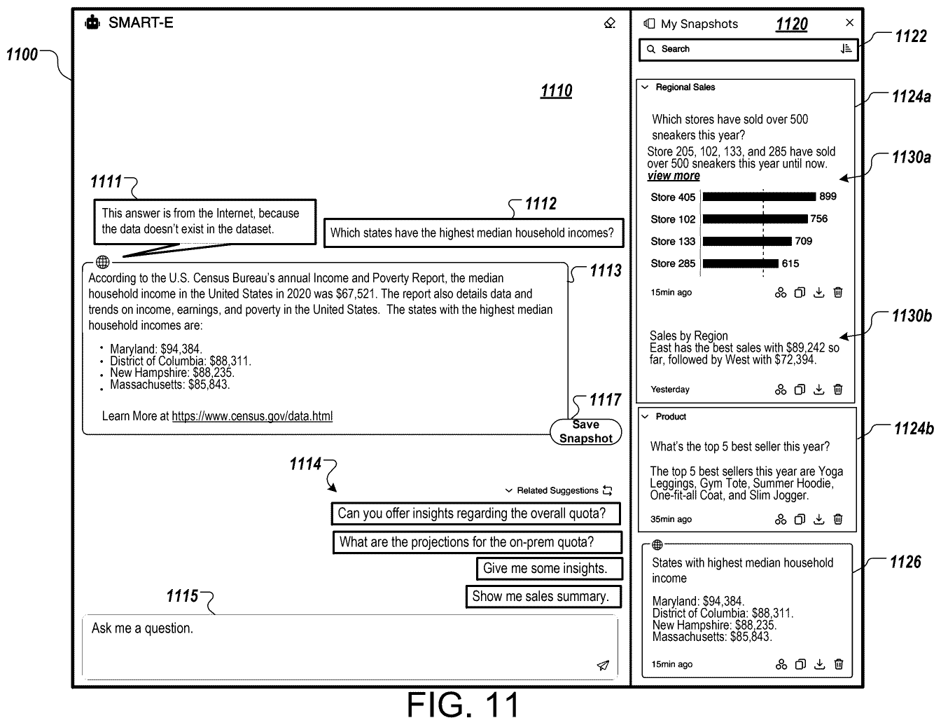

FIG. 11 is another example of a user interface 1100 showing user interactions with the chatbot. The user interface 1100 has a main area 1110 that shows a user prompt 1112 that was submitted and the response 1113 from the chatbot. The chatbot added a comment 1111 that the answer is taken from the Internet data because the data requested about median incomes by state was not in the data set 122a. In this example, the administrator 103 previously specified that the chatbot can use data from the Internet, by setting control 625 of FIG. 6B appropriately. As a result, the chatbot was able to determine from the initial request for data processing instructions and lookup from the data set 122a that the requested type of information was not available, and so the search should be expanded to include information from the Internet. The main area 1110 also includes a set of related suggestions 1114 that the chatbot provides. These suggestions can be selected based on prior prompts submitted by the current user, other users, and/or statistical likelihoods, even potentially from information generated from a LLM such as one of the AI/ML models 132.

The user interface 1110 also includes a snapshot area 1120 for viewing, searching, and organizing saved information from conversations with the chatbot. When a user finds information in the chat conversation to be helpful, the user can save the response for later viewing or other use by interacting with a save control 1117. In response, the computer system 110 creates and saves a record representing the corresponding prompt 1112 and response 1113, in this case, as snapshot 1126. The snapshots can be concise or summarized versions of the corresponding prompt and response, and these snapshots can be stored separately for each user. The stored snapshots can persist across different sessions of using the chatbot, and can be synchronized across different interfaces for accessing the chatbot. As a result, over the course of several different days, when the user accesses the chatbot at different times, and whether accessed from an embedded interface in a web application or from a stand-alone interface in a mobile app, the user can view the snapshots and add to them.

The snapshot area 1120 can include snapshots organized by topic or keyword, for example, a snapshot group 1124a includes a first question and answer 1130a as well as a second response to a question 1130b that is related. Another snapshot 1124b relates to another topic. Each snapshot 1130a, 1130b, 1124b, 1126 can include controls for the user to expand or contract the view, copy the snapshot content to a clipboard, share with other users, download the content, or delete the snapshot to remove it from the view 1120. The snapshot area 1120 also includes a search control that enables the user to perform text searching of the snapshots.

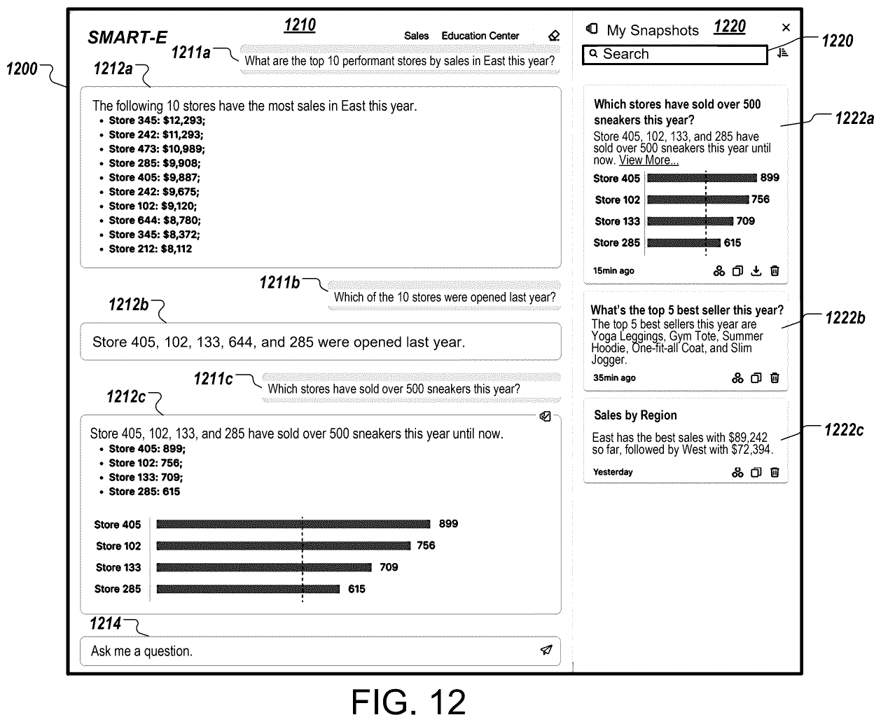

FIG. 12 is another example of a user interface 1200 for a user to interact with the chatbot. A main area 1210 includes various user prompts 1211a-1211c and corresponding responses 1212a-1212c of the chatbot, along with a prompt entry field 1214. In addition, the user interface 1200 includes a snapshot area 1220 with a search control 1220 and several saved snapshots 1222a-1222c that the user previously saved.

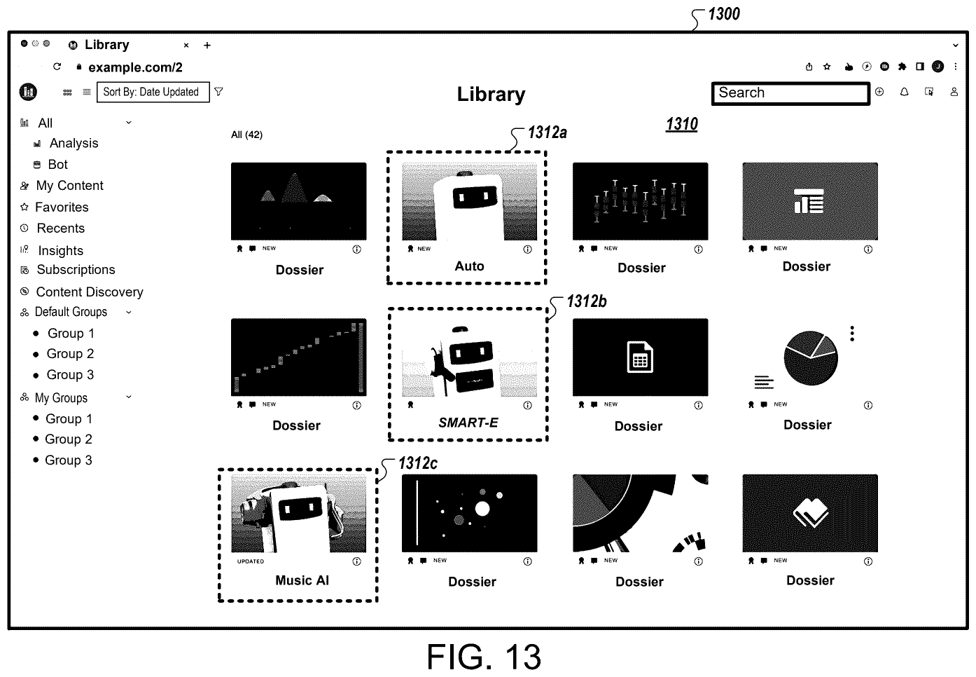

FIG. 13 shows an example of a library user interface 1300 where a user can access various types of information, such as documents, dashboards, databases, applications, and so on. The interface 1300 can include icons or other representations of chatbots 1312a-1312c. The interface 1300 enables the user to invoke any of these chatbots 1312a-1312c by interacting with the corresponding user interface element shown, which will initiate display of a text interface for the corresponding chatbot. The library user interface 1310 is yet another example of the many different entry points or access methods by which users can gain access to customized chatbots.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The invention claimed is:

1. A method performed by one or more computers, the method comprising:
storing, by the one or more computers, a knowledge base that comprises one or more knowledge items, wherein the knowledge base stores information for an organization;
receiving, by the one or more computers, a user prompt for a chatbot;
generating, by the one or more computers, a chatbot response to the user prompt using one or more artificial intelligence and/or machine learning (AI/ML) chatbots, wherein the chatbot response to the user prompt is generated at least in part based on the one or more AI/ML models processing the one or more knowledge items from the knowledge base; and
providing, by the one or more computers, the chatbot response for presentation.

2. The method of claim 1, comprising providing an interface having controls configured to enable one or more administrators or users to edit the knowledge base by adding, altering, or removing knowledge items from the knowledge base.

3. The method of claim 1, comprising:
providing an interface having controls configured to enable one or more administrators or users to designate or upload a file as knowledge base content; and
updating the knowledge base based on a file uploaded or designated for the knowledge base.

4. The method of claim 1, comprising initializing a session of interaction with the chatbot, including by providing at least some of the knowledge base to the one or more AI/ML models such that the provided at least some of the knowledge base is in the context of the one or more AI/ML models for generating responses to user prompts during the session.

5. The method of claim 4, wherein the at least some of the knowledge base is provided such that the provided at least some of the knowledge base is not included in a token count for incoming data to be processed by the one or more AI/ML models for user prompt processing during the session.

6. The method of claim 1, wherein the one or more AI/ML models comprise a large language model (LLM); and
wherein the one or more computers cause the one or more knowledge items to be included in a context window of the LLM when the LLM is used to generate the chatbot response.

7. The method of claim 1, comprising providing the one or more knowledge items to the one or more AI/ML models with a user prompt for the chatbot, such that the one or more AI/ML models receives the one or more knowledge items in association with the user prompt to generate the chatbot response.

8. The method of claim 1, wherein the one or more knowledge items comprise at least one of a definition, a meaning of a nickname or alias, a synonym relationship, a meaning of an abbreviation, an organizational hierarchy, or a criterion to apply.

9. The method of claim 1, wherein the one or more knowledge items indicate relationships between terminology used in the organization and data items indicated in a data model or data schema for one or more data sets that the chatbot is configured to answer questions about.

10. The method of claim 1, wherein the one or more knowledge items are customized for the organization and are shared among multiple users in the organization, such that chatbot responses for the multiple users in the organization are generated based on information from the same one or more knowledge items.

11. The method of claim 1, wherein the one or more knowledge items are configured to be used by each of multiple chatbots of the organization.

12. The method of claim 1, wherein the one or more knowledge items act as a persistent memory across multiple sessions of use or conversations, for a group of multiple users in an organization and across multiple different chatbots used in the organization.

13. The method of claim 1, wherein the one or more knowledge items are knowledge items are provided to the one or more AI/ML models as text or tokens representing text.

14. The method of claim 1, wherein the one or more knowledge items are provided to the one or more AI/ML models as embeddings.

15. The method of claim 1, wherein the one or more knowledge items comprise multiple knowledge items, and wherein the one or more computers are configured to selectively provide the multiple knowledge items to the one or more AI/ML models depending on the content of user prompts, such that different knowledge items or different subsets of the multiple knowledge items are provided to the one or more AI/ML models for generating responses to different user prompts.

16. The method of claim 1, comprising:
storing the one or more knowledge items using a vector database; and
retrieving knowledge items for responding to a particular user prompt from the vector database.

17. A system comprising:
one or more computers; and
one or more computer-readable media storing instructions that are operable, when executed by the one or more computers, to cause the system to perform operations comprising:
storing, by the one or more computers, a knowledge base that comprises one or more knowledge items, wherein the knowledge base stores information for an organization;
receiving, by the one or more computers, a user prompt for a chatbot;
generating, by the one or more computers, a chatbot response to the user prompt using one or more artificial intelligence and/or machine learning (AI/ML) chatbots, wherein the chatbot response to the user prompt is generated at least in part based on the one or more AI/ML models processing the one or more knowledge items from the knowledge base; and
providing, by the one or more computers, the chatbot response for presentation.

18. The system of claim 17, wherein the one or more AI/ML models comprise a large language model (LLM); and
wherein the one or more computers cause the one or more knowledge items to be included in a context window of the LLM when the LLM is used to generate the chatbot response.

19. The system of claim 18, wherein the one or more knowledge items comprise at least one of a definition, a meaning of a nickname or alias, a synonym relationship, a meaning of an abbreviation, an organizational hierarchy, or a criterion to apply.

20. One or more non-transitory computer-readable media storing instructions that are operable, when executed by one or more computers, to cause the one or more computers to perform operations comprising:
storing, by the one or more computers, a knowledge base that comprises one or more knowledge items, wherein the knowledge base stores information for an organization;
receiving, by the one or more computers, a user prompt for a chatbot;
generating, by the one or more computers, a chatbot response to the user prompt using one or more artificial intelligence and/or machine learning (AI/ML) chatbots, wherein the chatbot response to the user prompt is generated at least in part based on the one or more AI/ML models processing the one or more knowledge items from the knowledge base; and
providing, by the one or more computers, the chatbot response for presentation.
